(19) United States
(12) Patent Application Publication
(10) Pub. No.: US 2014/0153500 A1
(43) Pub. Date: Jun. 5, 2014

(54) METHODS, SYSTEMS, AND DEVICES FOR CONFIGURING MAXIMUM TRANSMIT POWER

(71) Applicant: QUALCOMM INCORPORATED, San Diego, CA (US)

(72) Inventors: Long DUAN, San Diego, CA (US); Soumya DAS, San Diego, CA (US); Edwin Chongwoo PARK, San Diego, CA (US); Ozgur DURAL, San Diego, CA (US); Peter Anthony BARANY, San Diego, CA (US)

(73) Assignee: QUALCOMM INCORPORATED, San Diego, CA (US)

(21) Appl. No.: 13/828,508

(22) Filed: Mar. 14, 2013

Related U.S. Application Data
(60) Provisional application No. 61/732,827, filed on Dec. 3, 2012.

(51) Int. Cl. H04W 52/24

(52) U.S. Cl. CPC H04W 52/24
USPC 370/329

(57) ABSTRACT

Methods, systems, and devices are disclosed for configuring maximum allowed transmit power for wireless communications systems. Some embodiments treat multiple traffic types, such as voice traffic and data traffic, separately with respect to one or more maximum allowed transmit power limits. In some cases, at least first transmit power limit for at least a first traffic type and/or at least a second transmit power limit for at least a second traffic type may be determined. At least the first transmit power limit with respect to the first traffic type or the second transmit power limit with respect to the second traffic type may be utilized. Some embodiments are configured to utilize flexible bandwidth carriers.

### RELATED APPLICATIONS

The present application for Patent claims priority to Provisional Application No. 61/732,827 entitled “MAXIMUM TRANSMIT POWER CONTROL METHODS, SYSTEMS, AND DEVICES” filed Dec. 3, 2012, and assigned to the assignee hereof and hereby expressly incorporated by reference herein for all purposes.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, 3GPP Long Term Evolution (LTE) systems, and orthogonal frequency-division multiple access (OFDMA) systems.

Service providers are typically allocated blocks of frequency spectrum for exclusive use in certain geographic regions. These blocks of frequencies are generally assigned by regulators regardless of the multiple access technology being used. In most cases, these blocks are not integer multiple of channel bandwidths, hence there may be unutilized parts of the spectrum. As the use of wireless devices has increased, the demand for and value of this spectrum has generally increased, as well. Nonetheless, in some cases, wireless communications systems may not utilize portions of the allocated spectrum because the portions are not big enough to fit a standard or normal waveform. The developers of the LTE standard, for example, recognized the problem and decided to support many different system bandwidths (e.g., 1.4, 3, 5, 10, 15 and 20 MHz). This may provide a partial solution to the problem. Flexible bandwidth carriers may provide another solution to these problems.

With flexible bandwidth carriers, such as for a flexible bandwidth carrier system, the spreading code chip rate may generally be reduced and, correspondingly, the signal bandwidth may be reduced. On the uplink, with the reduced signal bandwidth, the maximal transmission power per UE may also be reduced if the same power spectrum density (PSD) is maintained and correspondingly the maximum data throughput may also be reduced. For voice traffic, however, the data rate generally cannot be reduced and to maintain the sufficient voice coverage at the edge of the cell in flexible bandwidth carrier systems, for example, the maximum allowed transmission power generally cannot be reduced as the bandwidth decreases. Blindly keeping the maximum allowed power unchanged, however, may increase the signal PSD and may cause interference increase and number of users decrease in the system.

### SUMMARY

Methods, systems, and devices are provided for configuring maximum allowed transmit power over a flexible bandwidth carrier. These tools and techniques may address problems that may be introduced through the use of flexible bandwidth carrier systems with respect to maximum allowed transmit power through treating different traffic types or service types, such as a voice traffic type and regular best effort data traffic type, separately with respect to dealing with the maximum allowed transmission power limit. To balance the coverage, interference, and/or capacity considerations, combined approaches may be utilized. In some cases, the same maximum allowed transmission power for voice traffic type and the same PSD for data traffic type may be maintained. For example, the existing 3GPP constraint that P_MAX may be the total allowed maximum transmission power for the UE may be subject to change also. Instead of maintaining a single maximum allowed transmission power, some wireless communications systems, such as flexible bandwidth carrier systems, may also consider maintaining P_MAX_voice and P_MAX_data as separate maximum allowed transmission power limits for voice (or fixed rate traffic) and data traffic types (or best effort).

For example, methods, systems, and devices are provided for configuring maximum allowed transmit power for wireless communications systems. Some embodiments treat multiple traffic types, such as voice traffic and data traffic, separately with respect to one or more maximum allowed transmit power limits. In some cases, at least first transmit power limit for at least a first traffic type and/or at least a second transmit power limit for at least a second traffic type may be determined. At least the first transmit power limit with respect to the first traffic type or the second transmit power limit with respect to the second traffic type may be utilized. Some embodiments are configured to utilize flexible bandwidth carriers.

Flexible bandwidths carriers may involve wireless communications systems that may utilize portions of spectrum that may not be big enough to fit a normal waveform utilizing flexible waveforms. A flexible bandwidth carrier may be generated with respect to a normal carrier bandwidth system through dilating the time or scaling down the chip rate of the flexible bandwidth carrier with respect to the normal carrier bandwidth system. Some embodiments increase the bandwidth of a flexible waveform through expanding the time or scaling up the chip rate of the flexible carrier bandwidth system.

Some embodiments include a method of configuring maximum allowed transmit power for a wireless communications system. The method may include: determining at least first transmit power limit for at least a first traffic type; determining at least a second transmit power limit for at least a second traffic type; and/or utilizing at least the first transmit power limit with respect to the first traffic type or the second transmit power limit with respect to the second traffic type.

In some embodiments, the first traffic type includes a voice traffic type and the second traffic type includes at least a data traffic type. The first traffic type may include a voice service in some cases. In some embodiments, at least the first traffic type or the second traffic type includes a data service. The first traffic type and the second traffic type may utilize different carriers.

Some embodiments include adjusting a pilot to traffic power ratio based on a bandwidth scaling factor of the wireless communication system. Some embodiments include: determining one or more gain factors with respect to the adjusted pilot to traffic power ratio; and/or utilizing the one or more gain factors with respect to the adjusted pilot to traffic power ratio.

Some embodiments include transmitting the two or more transmit power limits. Some embodiments include receiving the two or more transmit power limits.

In some embodiments, the first transmit power limit includes a maximum total transmit power. In some embodiments, at least second transmit power limit includes a maximum total scaled transmit power. The maximum scaled transmit power may maintain a fixed power spectrum density (P SD) with respect to a normal bandwidth system. The maximum total scaled transmit power may scale logarithmically with a bandwidth scaling factor of a flexible bandwidth carrier system in some cases. For example, the maximum total scaled transmit power equals a maximum total transmit power minus floor (10 Log 10 N), where N equals the bandwidth scaling factor of the flexible bandwidth carrier system.

In some embodiments, a base station determines at least the first transmit power limit or the second transmit power limit and transmits them to one or more user equipment. In some embodiments, a user equipment determines at least the first transmit power limit or the second transmit power limit with respect to a maximum total transmit power.

The wireless communications system may include a flexible bandwidth carrier system. The wireless communications system may include at least a multi-carrier system or a multi-cell system.

Some embodiments include wireless communications system for configuring maximum allowed transmit power. The wireless communications system may include: means for determining at least first transmit power limit for at least a first traffic type; means for determining at least a second transmit power limit for at least a second traffic type; and/or means for utilizing at least the first transmit power limit with respect to the first traffic type or the second transmit power limit with respect to the second traffic type.

In some embodiments of the wireless communications system, the first traffic type includes a voice traffic type and the second traffic type includes at least a data traffic type. Some embodiments include means for transmitting the one or more transmit power limits. Some embodiments include means for receiving the one or more transmit power limits.

In some embodiments of the wireless communications system, the first transmit power limit includes a maximum total transmit power. In some embodiments, at least second transmit power limit includes a maximum total scaled transmit power. In some embodiments, the maximum scaled transmit power maintains a fixed power spectrum density (PSD) with respect to a normal bandwidth system. In some embodiments, the maximum total scaled transmit power scales logarithmically with a bandwidth scaling factor of a flexible bandwidth carrier system. For example, the maximum total scaled transmit power may equal a maximum total transmit power minus floor (10 Log 10 N), where N equals the bandwidth scaling factor of the flexible bandwidth carrier system.

In some embodiments of the wireless communications system, a base station determines at least the first transmit power limit or the second transmit power limit and transmits them to one or more user equipment. In some embodiments of the wireless communications system, a user equipment determines at least the first transmit power limit or the second transmit power limit with respect to a maximum total transmit power. Some embodiments include means for adjusting a pilot to traffic power ratio based on a bandwidth scaling factor. Some embodiments include means for determining one or more gain factors with respect to the adjusted pilot to traffic power ratio.

In some embodiments of the wireless communications system, the wireless communications system includes a flexible bandwidth carrier system. The wireless communications system may include at least a multi-carrier system or a multi-cell system.

Some embodiments include a computer program product for configuring maximum allowed transmit power for a wireless communications system that may include a non-transitory computer-readable medium that may include: code for determining at least first transmit power limit for at least a first traffic type; code for determining at least a second transmit power limit for at least a second traffic type; and/or code for utilizing at least the first transmit power limit with respect to the first traffic type or the second transmit power limit with respect to the second traffic type.

In some embodiments of the computer program product, the first traffic type includes a voice traffic type and the second traffic type includes at least a data traffic type. Some embodiments include code for transmitting the one or more transmit power limits. Some embodiments include code for receiving the one or more transmit power limits.

In some embodiments of the computer program product, the first transmit power limit includes a maximum total transmit power. In some embodiments, at least second transmit power limit includes a maximum total scaled transmit power. In some embodiments, the maximum scaled transmit power maintains a fixed power spectrum density (PSD) with respect to a normal bandwidth system. In some embodiments, the maximum total scaled transmit power may scale logarithmically with a bandwidth scaling factor of a flexible bandwidth carrier system. For example, the maximum total scaled transmit power may equal a maximum total transmit power minus floor (10 Log 10 N), where N equals the bandwidth scaling factor of the flexible bandwidth carrier system.

In some embodiments of the computer program product, a base station determines at least the first transmit power limit or the second transmit power limit and transmits them to one or more user equipment. In some embodiments of the computer program product, a user equipment determines at least the first transmit power limit or the second transmit power limit with respect to a maximum total transmit power.

Some embodiments include code for adjusting a pilot to traffic power ratio based on a bandwidth scaling factor. Some embodiments include code for determining one or more gain factors with respect to the adjusted pilot to traffic power ratio.

In some embodiments of the computer program product, the wireless communications system includes a flexible bandwidth carrier system.

Some embodiments include wireless communications device for configuring maximum allowed transmit power in a wireless communications system. The wireless communications device may include at least one processor that may be configured to: determine at least first transmit power limit for at least a first traffic type; determine at least a second transmit power limit for at least a second traffic type; and/or utilize at least the first transmit power limit with respect to the first traffic type or the second transmit power limit with respect to the second traffic type.

In some embodiments of the wireless communications device, the first traffic type includes a voice traffic type and the second traffic type includes at least a data traffic type.

In some embodiments, at least one processor is further configured to transmit the one or more transmit power limits. In some embodiments, the at least one processor is further configured to receive the one or more transmit power limits.

In some embodiments of the wireless communications device, the first transmit power limit includes a maximum total transmit power. In some embodiments of the wireless communications device, at least second transmit power limit includes a maximum total scaled transmit power. The maximum scaled transmit power may maintain a fixed power spectrum density (P SD) with respect to a normal bandwidth system in some cases. The maximum total scaled transmit power may scale logarithmically with a bandwidth scaling factor of a flexible bandwidth carrier system. For example, the maximum total scaled transmit power may equal a maximum total transmit power minus floor (10 Log 10 N), where N equals the bandwidth scaling factor of the flexible bandwidth carrier system.

In some embodiments of the wireless communications device, a base station determines at least the first transmit power limit or the second transmit power limit and transmits them to one or more user equipment. Some embodiments include the at least one processor is further configured to adjust a pilot to traffic power ratio based on a bandwidth scaling factor. The at least one processor may further configured to determine one or more gain factors with respect to the adjusted pilot to traffic power ratio. In some embodiments of the wireless communications device, a user equipment determines at least the first transmit power limit or the second transmit power limit with respect to a maximum total transmit power.

In some embodiments of the wireless communications device, the wireless communications system includes a flexible bandwidth carrier system.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2A shows an example of a wireless communications system where a flexible waveform fits into a portion of spectrum not broad enough to fit a normal waveform in accordance with various embodiments;

FIG. 2B shows an example of a wireless communications system where a flexible waveform fits into a portion of spectrum near an edge of a band in accordance with various embodiments;

FIG. 3 shows a block diagram of a wireless communications system in accordance with various embodiments;

FIG. 4A shows a block diagram of a device for configuring maximum allowed transmit power in accordance with various embodiments;

FIG. 4B shows a block diagram of a device for configuring maximum allowed transmit power in accordance with various embodiments;

FIG. 5 shows a flow diagram for uplink maximum power control in accordance with various embodiments;

FIG. 6 shows a flow diagram for uplink maximum power control in accordance with various embodiments;

FIG. 7 shows a block diagram of a wireless communications system in accordance with various embodiments;

FIG. 8 shows a block diagram of a mobile device in accordance with various embodiments;

FIG. 9 shows a block diagram of a wireless communications system that includes a base station and a mobile device in accordance with various embodiments; and

FIG. 10A shows a flow diagram of a method for configuring maximum allowed transmit power in accordance with various embodiments;

FIG. 10B shows a flow diagram of a method for configuring maximum allowed transmit power in accordance with various embodiments; and

FIG. 10C shows a flow diagram of a method for configuring maximum allowed transmit power in accordance with various embodiments.

### DETAILED DESCRIPTION

Methods, systems, and devices are provided for configuring maximum allowed transmit power over a flexible bandwidth carrier. These tools and techniques may address problems that may be introduced through the use of flexible bandwidth carrier systems with respect to maximum allowed transmit power through treating different traffic types or service types, such as the voice traffic type and regular best effort data traffic type, separately with respect to dealing with the maximum allowed transmission power limit. To properly balance the coverage, interference, and/or capacity considerations, combined approaches may be utilized. In some cases, the same maximum allowed transmission power for voice traffic type and with the same PSD for data traffic type may be maintained. For example, the existing 3GPP constraint that P_MAX may be the total allowed maximum transmission power for the UE may be subject to change also. Instead of maintaining a single maximum allowed transmission power, some wireless communications systems, such as flexible bandwidth carrier systems, may also consider maintaining P_MAX_voice and P_MAX_data as separate maximum allowed transmission power limits for voice (or fixed rate traffic) and data traffic types (or best effort).

In some cases, the voice traffic can be circuit switched (CS) for example. Also, voice can be considered one of many services. Data or a specific data service can be considered a service. Each service or a group of services may maintain a P_MAX_service as a separate maximum allowed transmission power for the service (or group of services). In some cases, an overarching P_MAX may be maintained for all the services.

Some embodiments may utilize multi-cells and/or multi-carriers. In some cases, services can be segment (either individually or in a group). The group may be on a per carrier basis or across carriers. Each grouping can have a max power and there can be max power for multiple groups. In some cases, the cells may not have the same bandwidths.

For example, one method of configuring maximum allowed transmit power for a wireless communications system may include identifying multiple traffic types. The multiple traffic types may be treated separately with respect to one or more maximum allowed transmit power limits. The multiple traffic types may include a voice traffic type and a data traffic type. The wireless communications system may utilize one or more flexible bandwidth carriers with respect to the multiple traffic types.

Another technique for configuring maximum allowed transmit power for a wireless communications system may include determining a first transmit power limit for a first traffic type. A second transmit power limit for a second traffic type may also be determined. The first transmit power limit with respect to the first traffic type or the second transmit power limit with respect to the second traffic type may be utilized. The wireless communications system may utilize one or more flexible bandwidth carriers with respect to the first traffic type and/or the second traffic type.

The first traffic type may include a voice traffic type and the second traffic type may include a data traffic type. Some options include transmitting and/or receiving the one or more transmit power limits. The first transmit power limit may include a maximum total transmit power. The second transmit power limit may include a maximum total scaled transmit power. The maximum scaled transmit power may maintain a fixed power spectrum density (PSD) with respect to a normal bandwidth system. The maximum total scaled transmit power may scale logarithmically with a bandwidth scaling factor. For example, the maximum total scaled transmit power may scaling logarithmically; for example, the maximum total scaled transmit power may equal a maximum total transmit power minus floor(10 Log₁₀) N), where N may equal a bandwidth scaling factor of a flexible bandwidth carrier system. In some cases, the maximal total scaled transmit power may be lowered by another number limited by other factors (e.g., components).

In some cases, a base station may determine at least the first transmit power limit or the second transmit power limit and may transmit them to one or more user equipment. A user equipment may determine at least the first transmit power limit or the second transmit power limit with respect to a maximum total transmit power in some cases. Some techniques include adjusting a pilot to traffic type power ratio based on a bandwidth scaling factor. Other techniques include determining one or more gain factors with respect to the adjusted pilot to traffic type power ratio.

The above tools and techniques may generally be applied with wireless communications system that may utilize flexible bandwidth carriers. However, the tools and techniques may be applicable to more general wireless communications systems that may utilize normal bandwidth carriers.

In 3G/4G wireless systems, the maximum user equipment (UE) transmission power in the system is generally controlled by the network. The proper maintenance of UE maximum transmission power may be important for achieving effective balance between coverage, interference and network capacity. For instance, in existing 3GPP UMTS systems, this maximum power may be referred to as P_MAX, which may be signaled to UE via RRC signaling.

In flexible bandwidth carrier systems, the spreading code chip rate may be reduced and, correspondingly, the signal bandwidth may be reduced. On the uplink, with the reduced signal bandwidth, the maximal signal transmission power per UE may also be reduced if the same power spectrum density (PSD) is maintained, for example. If the same maximal transmission power (P_MAX) per UE is not to be reduced, the corresponding power spectrum density (PSD) may be increased. Currently, in existing 3GPP standards, P_MAX is generally the total allowed maximum transmission power for the UE, and a UE may transmit on multiple channels supporting multiple services simultaneously.

There may be different pros and cons for maintaining the same PSD or maintaining the same P_MAX. With respect to spectrum efficiency, maintaining the PSD per user, the signal-to-noise ratio (SNR) per second per hertz may not be changed. The spectrum efficiency may not be changed. Maintaining the same P_MAX per user, the PSD may be increased as the bandwidth is reduced. Hence, with background interference unchanged, SNR per second per hertz may be increased. At high SNR regions, such as close to the base station, the increase SNR, however, may not translate to the increased spectrum efficiency when the largest MCS is used already. Unless the coding/modulation scheme may be changed or the UE transmit at power may be lower than it would otherwise, the spectrum efficiency may be reduced at such high SNR regions. At the medium/low SNR regions, there may be no change in the efficiency. Looking at the secondary effect, the increased transmission power of individual users may result in overall interference increase in the system due to the “CDMA” effect, which may also limited SNR (and data rate) increases for those individual users.

With respect to user data rate, when maintaining the same PSD per user, maximum TX power may be reduced as the bandwidth is reduced. The individual user peak data rate may also be reduced accordingly. When maintaining the same P_MAX per user, the individual user data rate may not be changed at the medium/low SNR region. However, with reduced the spectrum efficiency at the high SNR region, the data rate may be limited, but may not be lower than what is observed in the PSD limiting case.

With respect to coverage, when maintain the same PSD per user, the coverage may not be changed due to the reduced data rate. This may be acceptable for data users. For voice users, the coverage for voice may be reduced since the voice data rate may not be reduced. For users with a constant rate on networks that share some properties optimized for coverage in a normal bandwidth system, the coverage area may be reduced. In the case where P_MAX may be maintained, the same data rate may be maintained at the edge of the coverage provided that the data rate may be supported in the flexible bandwidth system.

With respect to interference, from the uplink interference power point of view, on average, the interference may be reduced because of the lower transmission power due reduced bandwidth when the PSD per user is maintained. However, the rise-over-thermal (ROT) may not be reduced because the thermal noise is also reduced. The number of users in the cell and the distribution of users in the cell may be assumed to not change. For the case of maintaining the P_MAX per user, in terms of power, the interference level seen on the uplink may not be changed, because P_MAX is the same, considering the same number of users in the cell and the same user distribution in the cell. However, for rise-over-thermal (ROT), the interference level may actually be increased, i.e., the ROT may be increased due to the fact that the thermal noise is reduced. Note that the ROT increase may not be linear as the interference in the system increases. With the same amount of users in the cell and the total transmission power of each user unchanged, the ROT increase may be more than doubled when the bandwidth is reduced by half, for example. To maintain the same ROT level, the number of users in the cell may be reduced.

In some cases, a flexible bandwidth carrier system may allow operators to maximally utilize the existing investment (such as bandwidth, network deployment, cell site towers), and yet, adopt new technologies and services. For instance, deploying flexible bandwidth carrier system may allow operators to replace existing GSM systems with UMTS based systems without altering a large chunk of signal band. However, the UMTS based system may need to be able to maintain the same cellular coverage infrastructure, i.e., no additional cell site to be added. This implies that UE, at the edge of the cell, may be allowed to transmit the same maximum power to make voice calls with respect to the normal BW system. Hence, in this case, the PSD may be increase accordingly.

Increasing PSD may have impacts on performance and interference as discussed above. In particular, the link performance may be degraded due to interference increase, and the cell capacity may be decreased with respect to a flexible bandwidth system with that maintained the same PSD as a normal bandwidth system.

To properly balance the coverage, interference and capacity considerations, combined approaches may be utilized, where the same maximum transmission power for voice traffic and same PSD for data traffic may be maintained. For the same reason, the existing 3GPP constraint that P_MAX is the total allowed maximum transmission power for the UE may also subject to change. Instead of maintaining a single maximum transmission power, flexible bandwidth carrier system and/or other flexible or even normal bandwidth systems may also consider maintaining P_MAX_voice and P_MAX_data as separate maximum transmission power limits for voice (or fixed rate traffic) and (best effort) data traffic.

Techniques described herein may be used for various wireless communications systems such as CDMA, TDMA, FDMA, OFDMA, SC-FDMA, Peer-to-Peer, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA or OFDM system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

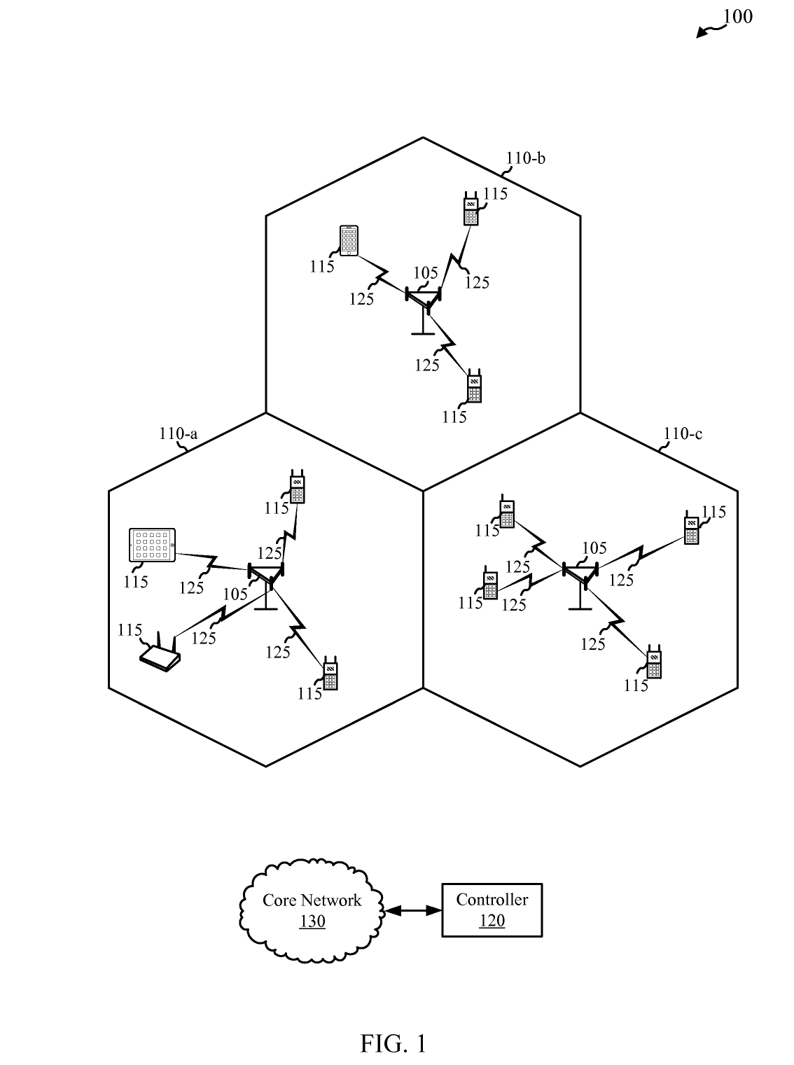

Referring first to FIG. 1, a block diagram illustrates an example of a wireless communications system 100 in accordance with various embodiments. The system 100 includes base stations 105, user equipment 115, a base station controller 120, and a core network 130 (the controller 120 may be integrated into the core network 130 in some embodiments; in some embodiments, controller 120 may be integrated into base stations 105). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The user equipment 115 may be any type of mobile station, mobile device, access terminal, subscriber unit, or user equipment. The user equipment 115 may include cellular phones and wireless communications devices, but may also include personal digital assistants (PDAs), smartphones, other handheld devices, netbooks, notebook computers, etc. Thus, the term user equipment should be interpreted broadly hereinafter, including the claims, to include any type of wireless or mobile communications device.

The base stations 105 may wirelessly communicate with the user equipment 115 via a base station antenna. The base stations 105 may be configured to communicate with the user equipment 115 under the control of the controller 120 via multiple carriers. Each of the base station 105 sites can provide communication coverage for a respective geographic area. In some embodiments, base stations 105 may be referred to as a NodeB, eNodeB, Home NodeB, and/or Home eNodeB. The coverage area for each base station 105 here is identified as 110-a, 110-b, or 110-c. The coverage area for a base station may be divided into sectors (not shown, but making up only a portion of the coverage area). The system 100 may include base stations 105 of different types (e.g., macro, micro, femto, and/or pico base stations).

The different aspects of system 100, such as the user equipment 115, the base stations 105, the core network 130, and/or the controller 120 may be configured to utilize flexible bandwidth and waveforms in accordance with various embodiments. System 100, for example, shows transmissions 125 between user equipment 115 and base stations 105. The transmissions 125 may include uplink and/or reverse link transmission, from a user equipment 115 to a base station 105, and/or downlink and/or forward link transmissions, from a base station 105 to a user equipment 115. The transmissions 125 may include flexible and/or normal waveforms. Normal waveforms may also be referred to as legacy and/or normal waveforms.

The different aspects of system 100, such as the user equipment 115, the base stations 105, the core network 130, and/or the controller 120 may be configured to utilize flexible bandwidth and waveforms in accordance with various embodiments. For example, different aspects of system 100 may utilize portions of spectrum that may not be big enough to fit a normal waveform. Devices such as the user equipment 115, the base stations 105, the core network 130, and/or the controller 120 may be configured to adapt the chip rates and/or scaling factors to generate and/or utilize flexible bandwidth and/or waveforms. Some aspects of system 100 may form a flexible subsystem (such as certain user equipment 115 and/or base stations 105) that may be generated with respect to a normal subsystem (that may be implemented using other user equipment 115 and/or base stations 105) through dilating, or scaling down, the time of the flexible subsystem with respect to the time of the normal subsystem.

In some embodiments, the different aspects of system 100, such as the user equipment 115, the base stations 105, the core network 130, and/or the controller 120 may be configured to configure maximum allowed transmit power for aspects of system 100. For example, in some embodiments, the different aspects of system 100, such as the user equipment 115, the base stations 105, the core network 130, and/or the controller 120 may be configured to treat the multiple traffic types separately with respect to one or more maximum allowed transmit power limits. The multiple traffic types may include a voice traffic and a data traffic.

The different aspects of system 100, such as the user equipment 115, the base stations 105, the core network 130, and/or the controller 120 may be configured to determine at least first transmit power limit for at least a first traffic type and/or determine at least a second transmit power limit for at least a second traffic type. At least the first transmit power limit with respect to the first traffic type or the second transmit power limit with respect to the second traffic type may be utilized by different aspects of system 100. The first traffic type may include a voice traffic type and the second traffic type includes at least a data traffic type.

The different aspects of system 100, such as the user equipment 115, the base stations 105, the core network 130, and/or the controller 120 may be configured to transmitting and/or receiving the one or more transmit power limits. The first transmit power limit may include a maximum total transmit power. The second transmit power limit may include a maximum scaled transmit power. The maximum scaled transmit power may maintain a fixed power spectrum density (PSD) with respect to a normal bandwidth system. In some cases, the maximum scaled transmit power may be maintained with respect to another fixed PSD that may not be associated with a normal bandwidth carrier system. The maximum total scaled transmit power may be scaled logarithmically with a bandwidth scaling factor of a flexible bandwidth carrier system. For example, the maximum total scaled transmit power may equal a maximum total transmit power minus floor (10 Log₁₀) N), where N equals the bandwidth scaling factor of the flexible bandwidth carrier system. While some cases may utilize a floor, other cases may utilizing rounding, a look-up table, and/or do nothing

In some embodiment, base stations 105, core network 105, and/or controller 120 may be configured for determining at least the first transmit power limit or the second transmit power limit and transmits them to one or more user equipment 115. In some embodiments, user equipment 115 may be configured for determining at least the first transmit power limit or the second transmit power limit with respect to a maximum total transmit power.

Some embodiments may include user equipment and/or base stations, such as user equipment 115 and/or base stations 105 of system 100 of FIG. 1, that may generate flexible waveforms and/or normal waveforms. Flexible waveforms may occupy less bandwidth than a normal waveform. For example, at a band edge, there may not be enough available spectrum to place a normal waveform. For a flexible waveform in some embodiments, as time gets dilated, the frequency occupied by a waveform goes down, thus making it possible to fit a flexible waveform into spectrum that may not be broad enough to fit a normal waveform. Flexible waveforms may also be generated in some embodiments through using a scaling factor. Other embodiments may generate a flexible waveform to fit a portion of spectrum through altering a rate or chip rate (e.g., a spreading factor may change). Some embodiments may change a frequency of processing to change a chip rate or utilize a scaling factor. Changing frequency of processing may include changing an interpolation rate, an interrupt rate, and/or a decimation rate. In some embodiments, a chip rate may be changed or a scaling factor utilized through filtering, by decimation, and/or by changing a frequency of an ADC, a DAC, and/or an offline clock. A divider may be used to change the frequency of at least one clock.

In some embodiments, a flexible system or waveform may be a fractional system or waveform. Fractional systems and/or waveforms may or may not change bandwidth for example. A fractional system or waveform may be flexible because it may offer more possibilities than a normal system or waveform (e.g., N=1 system). A normal system or waveform may refer to a standard and/or legacy system or waveform.

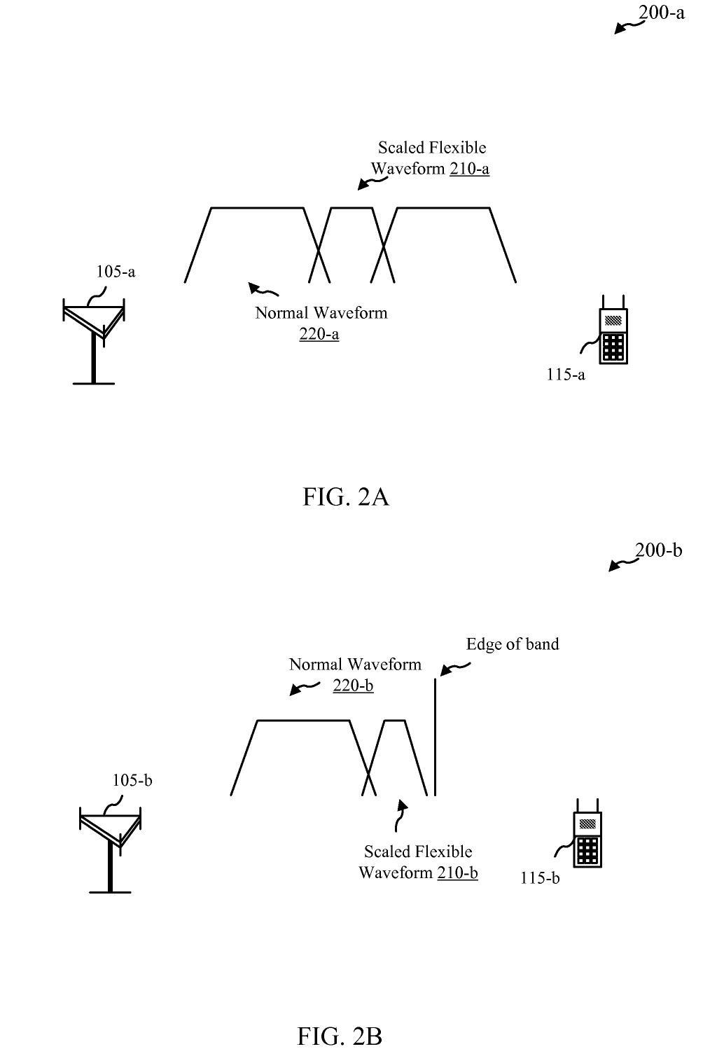

FIG. 2A shows an example of a wireless communications system 200-a with a base station 105-a and a user equipment 115-a in accordance with various embodiments, where a flexible waveform 210-a fits into a portion of spectrum not broad enough to fit a normal waveform 220-a. System 200-a may be an example of system 100 of FIG. 1. In some embodiments, the flexible waveform 210-a may overlap with the normal waveform 220-a that either the base station 105-a and/or the user equipment 115-a may transmit. In some cases, the normal waveform 220-a may completely overlap the flexible waveform 210-a. Some embodiments may also utilize multiple flexible waveforms 210. In some embodiments, another base station and/or user equipment (not shown) may transmit the normal waveform 220-a and/or the flexible waveform 210-a. FIG. 2B shows an example of a wireless communications system 200-b with a base station 105-b and user equipment 115-b, where a flexible waveform 210-b fits into a portion of spectrum near an edge of a band, which may be a guard band, where normal waveform 220-b may not fit. System 200-b may be an example of system 100 of FIG. 1. Aspects of systems 200-a and/or 200-b may be configured to configure maximum allowed transmit power for aspects of system 200-a and/or 200b. Aspects of systems 200-a and/or 200-b may be configured to treat the multiple traffic types separately with respect to one or more maximum allowed transmit power limits. The multiple traffic types may include a voice traffic type and a data traffic type. Aspects of systems 200-a and/or 200-b may be configured to determine at least first transmit power limit for at least a first traffic type and/or determine at least a second transmit power limit for at least a second traffic type. At least the first transmit power limit with respect to the first traffic type or the second transmit power limit with respect to the second traffic type may be utilized by different aspects of system 100. The first traffic type may include a voice traffic and the second traffic includes at least a data traffic.

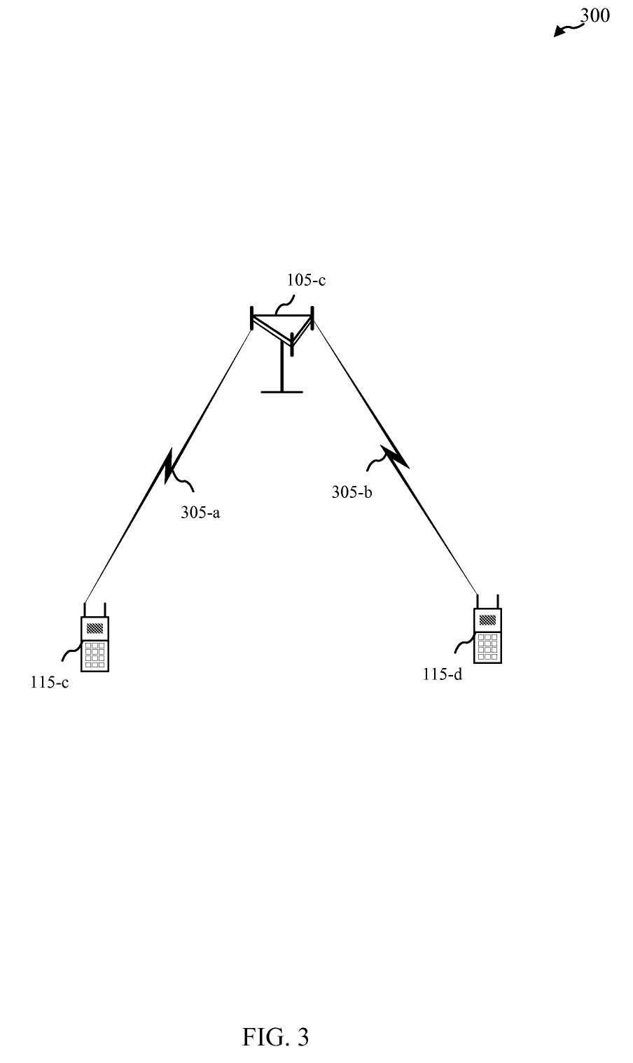

FIG. 3 shows a wireless communications system 300 with a base station 105-c and user equipment 115-c and 115-d, in accordance with various embodiments. In some embodiments, the base station 105-c and/or the user equipment 115-c/115-d may be configured for providing services, such as voice services, within a flexible bandwidth carrier. For example, transmissions 305-a and/or 305-b between the user equipment 115-c/115-d and the base station 105-c may involve transmissions that have been scaled utilizing flexible waveforms.

The base station 105-c and/or the user equipment 115-c/115-d may be configured to configure maximum allowed transmit power for aspects of system 300. The base station 105-c and/or the user equipment 115-c/115-d may be configured to treat the multiple traffic types separately with respect to one or more maximum allowed transmit power limits. The multiple traffic types may include a voice traffic and a data traffic. The base station 105-c and/or the user equipment 115-c/115-d may configured to determine at least first transmit power limit for at least a first traffic type and/or determine at least a second transmit power limit for at least a second traffic type. At least the first transmit power limit with respect to the first traffic type or the second transmit power limit with respect to the second traffic type may be utilized by different aspects of system 300. The first traffic type may include a voice traffic and the second traffic includes at least a data traffic.

The base station 105-c and/or the user equipment 115-c/115-d may be configured to transmitting and/or receiving the one or more transmit power limits. The first transmit power limit may include a maximum total transmit power. The second transmit power limit may include a maximum scaled transmit power. The maximum scaled transmit power may maintain a fixed power spectrum density (PSD) with respect to a normal bandwidth system. In some cases, the maximum scaled transmit power may be maintained with respect to another fixed PSD that may not be associated with a normal bandwidth carrier system. The maximum total scaled transmit power may be scaled logarithmically with a bandwidth scaling factor of a flexible bandwidth carrier system. For example, the maximum total scaled transmit power may equal a maximum total transmit power minus floor (10 Log₁₀ N), where N equals the bandwidth scaling factor of the flexible bandwidth carrier system.

In some embodiment, the base station 105-c may be configured for determining at least the first transmit power limit or the second transmit power limit and transmits them to one or more user equipment 115-c and/or 115-d. In some embodiments, user equipment 115-c and/or 115-d may be configured for determining at least the first transmit power limit or the second transmit power limit with respect to a maximum total transmit power.

Transmissions 305-a and/or 305-b between the user equipment 115-c/115-d and the base station 105-c may utilize flexible waveforms that may be generated to occupy less (or more) bandwidth than a normal waveform. For example, at a band edge, there may not be enough available spectrum to place a normal waveform. For a flexible waveform, as time gets dilated, the frequency occupied by a waveform goes down, thus making it possible to fit a flexible waveform into spectrum that may not be broad enough to fit a normal waveform. In some embodiments, the flexible waveform may be scaled utilizing a scaling factor N with respect to a normal waveform. Scaling factor N may take on numerous different values including, but not limited to, integer values such as 1, 2, 4, etc. N, however, does not have to be an integer.

Some embodiments may utilize additional terminology. A new unit D may be utilized. The unit D is dilated. It is unitless and has the value of N. One can talk about time in the flexible system in terms of “dilated time.” For example, a slot of say 10 ms duration in normal bandwidth carrier may be represented as 10 Dms as 10 Dms 10×Dcr ms=10 ms for a normal bandwidth carrier. In time scaling, one can replace most “seconds” with “dilated-seconds.” Note frequency in Hertz is 1/s. As noted above, some embodiments may also utilize a chip rate divider (“Dcr”), which may also have the value N.

As discussed above, a flexible waveform may be a waveform that occupies less bandwidth than a normal waveform. Thus, in a flexible bandwidth carrier, the same number of symbols and bits may be transmitted over a longer duration compared to a normal bandwidth carrier. This may result in time stretching, whereby slot duration, frame duration, etc., may increase by a scaling factor N. Scaling factor N may represent the ratio of the normal bandwidth to flexible bandwidth (BW). Thus, data rate in a flexible bandwidth carrier may equal (Normal Rate×1/N), and delay may equal (Normal Delay×N). In general, a flexible systems channel BW=channel BW of normal systems/N. Delay×BW may remain unchanged. Furthermore, in some embodiments, a flexible waveform may be a waveform that occupies more bandwidth than a normal waveform.

Throughout this specification, the term normal system, subsystem, and/or waveform may be utilized to refer to systems, subsystems, and/or waveforms that involve embodiments that may utilize a scaling factor that may be equal to one (e.g., N=1) or a normal or standard chip rate. These normal systems, subsystems, and/or waveforms may also be referred to as standard and/or legacy systems, subsystems, and/or waveforms. Furthermore, flexible systems, subsystems, and/or waveforms may be utilized to refer to systems, subsystems, and/or waveforms that involve embodiments that may utilize a scaling factor that may be not equal to one (e.g., N=2, 4, 8, ½, ¼, etc.). For N>1, or if a chip rate is decreased, the bandwidth of a waveform may decrease. Some embodiments may utilize scaling factors or chip rates that increase the bandwidth. For example, if N<1, or if the chip rate is increased, then a waveform may be expanded to cover bandwidth larger than a normal waveform. Flexible systems, subsystems, and/or waveforms may also be referred to as fractional systems, subsystems, and/or waveforms in some cases. Fractional systems, subsystems, and/or waveforms may or may not change bandwidth, for example. A fractional system, subsystem, or waveform may be flexible because it may offer more possibilities than a normal or standard system, subsystem, or waveform (e.g., N=1 system).

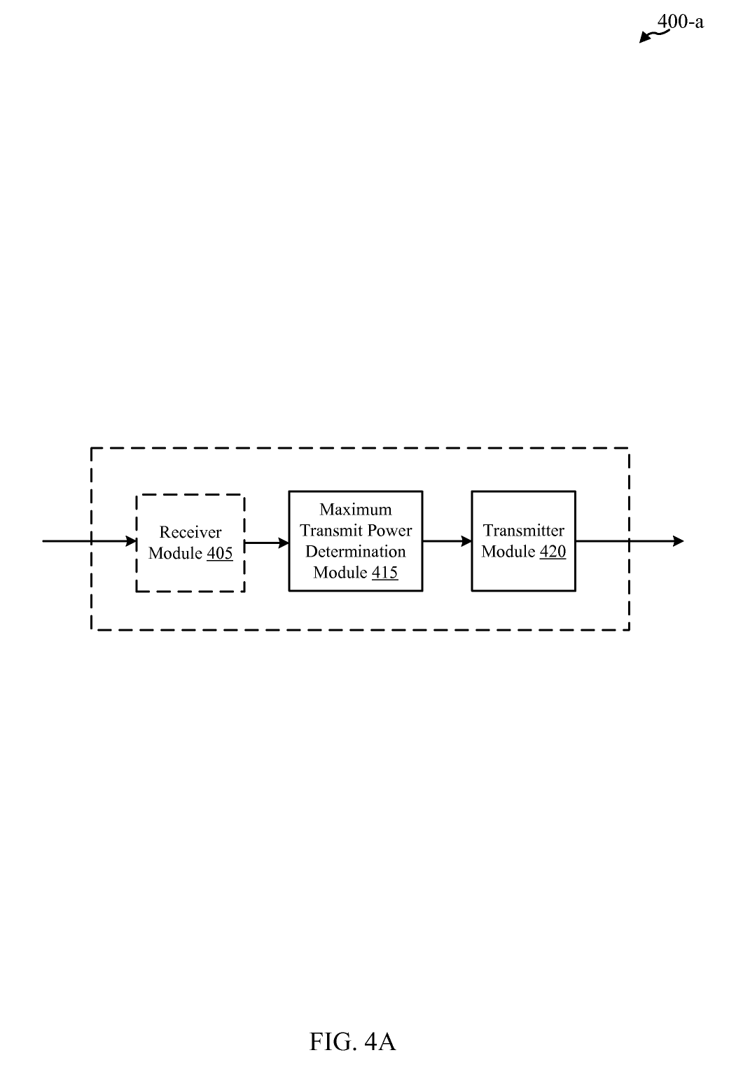

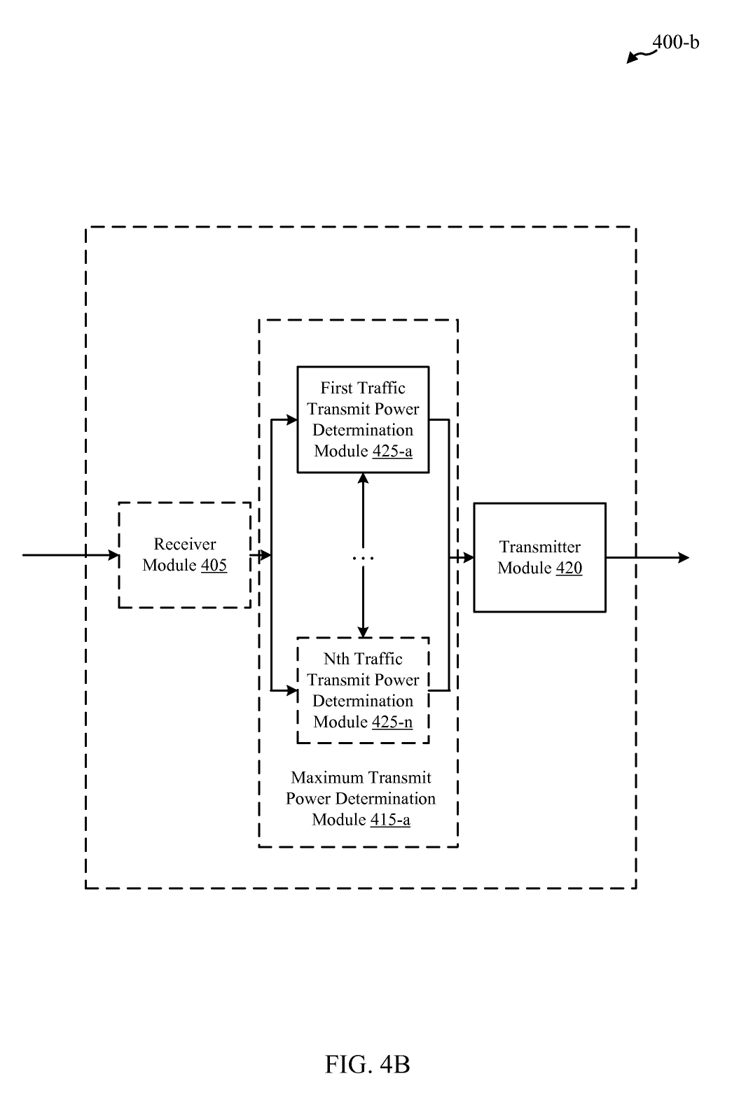

Turning next to FIG. 4A and FIG. 4B, a block diagram illustrates a device 400-a and a device 400-b, respectively, for configuring maximum allowed transmit power in accordance with various embodiments. The device 400-a and/or device 400-b may be an example of one or more aspects of base stations 105 described with reference to FIG. 1, FIG. 2, FIG. 3, FIG. 11, and/or FIG. 13. The device 400-a and/or device 400-b may be an example of one or more aspects of user equipment 115 described with reference to FIG. 1, FIG. 2, FIG. 3, FIG. 11, FIG. 12, and/or FIG. 13. The device 400 may also be a processor. The device 400-a may include a receiver module 405, a maximum transmit power determination module 415, and/or a transmitter module 420. In some cases, the maximum transmit power determination module 415 may be integrated with the transmitter module 420. Each of these components may be in communication with each other. The device 400-b may include a receiver module 405, a maximum transmit power determination module 415-a, and/or a transmitter module 420. In some cases, the maximum transmit power determination module 415-a may be integrated with the transmitter module 420. The maximum transmit power determination module 415-a may include multiple traffic type transmit power determination modules 425-a, . . . 425-n. Each of these components may be in communication with each other.

These components of the device 400-a and/or device 400-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

Device 400-a, through a maximum transmit power determination module 415, and/or device 400-b, through one or more of the transmit power determination modules 425 as aspects of maximum transmit power determination module 415-a, may be configured to identify multiple traffic types. Device 400-a, through a maximum transmit power determination module 415, and/or device 400-b, through one or more of the transmit power determination modules 425 as aspects of maximum transmit power determination module 415-a, may be configured to treat the multiple traffic types separately with respect to one or more maximum allowed transmit power limits. The multiple traffic types may include a voice traffic and a data traffic.

In some embodiments, device 400-a, through a maximum transmit power determination module 415, and/or device 400-b, through one or more of the transmit power determination modules 425 as aspects of maximum transmit power determination module 415-a, may be configured to determine at least first transmit power limit for at least a first traffic type and/or determine at least a second transmit power limit for at least a second traffic type. Device 400-a, through a maximum transmit power determination module 415 and/or transmitter module 420, and/or device 400-b, through one or more of the transmit power determination modules 425 as aspects of maximum transmit power determination module 415-a and/or the transmitter module 420, may be configured to utilizing at least the first transmit power limit with respect to the first traffic type or the second transmit power limit with respect to the second traffic type. The first traffic type may include a voice traffic and the second traffic includes at least a data traffic.

Some embodiments device 400-a and/or device 400-b, through transmitter module 420 and/or receiver module 405, may be configured to transmitting and/or receiving the one or more transmit power limits. The first transmit power limit may include a maximum total transmit power. The second transmit power limit may include a maximum scaled transmit power. The maximum scaled transmit power may maintain a fixed power spectrum density (PSD) with respect to a normal bandwidth system. In some cases, the maximum scaled transmit power may be maintained with respect to another fixed PSD that may not be associated with a normal bandwidth carrier system. The maximum total scaled transmit power may be scaled logarithmically with a bandwidth scaling factor of a flexible bandwidth carrier system. For example, the maximum total scaled transmit power may equal a maximum total transmit power minus floor (10 Log₁₀ N), where N equals the bandwidth scaling factor of the flexible bandwidth carrier system.

Some embodiments include adjusting a pilot to traffic power ratio based on a bandwidth scaling factor. Some embodiments include determining one or more gain factors with respect to the adjusted pilot to traffic power ratio.

In some embodiment, device 400-a and/or device 400-b may be configured as part of a base station for determining at least the first transmit power limit or the second transmit power limit and transmits them to one or more user equipment. In some embodiment, device 400-a and/or device 400-b may be configured as part of a user equipment for determining at least the first transmit power limit or the second transmit power limit with respect to a maximum total transmit power. Device 400-a and/or device 400-b may be part of a flexible bandwidth carrier system.

In some embodiments, device 400-a and/or device 400-b may be configured such that the first traffic type includes a voice service. In some embodiments, at least the first traffic type or the second traffic type includes a data service. In some embodiments, the first traffic type and the second traffic type utilize different carriers.

In some embodiments, device 400-a and/or device 400-b may be included as part of the wireless communications system that may include at least a multi-carrier system or a multi-cell system.

In some cases, device 400-a and/or device 400-b may allow operators, such as for flexible bandwidth carrier system operators, to maximally utilize the existing investment (such as bandwidth, network deployment, cell site towers), and yet, adopt new technologies and services. For instance, deploying flexible bandwidth carrier system utilizing devices such as device 400-a and/or device 400-b may allow operators to replace existing GSM systems with UMTS based systems without altering a large chunk of signal band. However, the UMTS based system may need to be able to maintain the same cellular coverage infrastructure, i.e., no additional cell site to be added. This implies that UE, at the edge of the cell, may be allowed to transmit the same maximum power to make voice calls with respect to the normal bandwidth system. Hence, in this case, the PSD may be increase accordingly.

Increasing PSD may have impacts on performance and interference as mentioned in the table above. In particular, the link performance may be degraded due to interference increase, and the cell capacity may be decreased with respect to a flexible bandwidth system with that maintained the same PSD as a normal bandwidth system.

To properly balance the coverage, interference and capacity considerations, combined approaches may be utilized that may involve device 400-a and/or device 400-b, where the same maximum transmission power for voice traffic and same PSD for data traffic may be maintained. For the same reason, the existing 3GPP constraint that P_MAX may be the total allowed maximum transmission power for the UE may also subject to change. Instead of maintaining a single maximum transmission power, flexible bandwidth carrier system and/or other flexible or even normal bandwidth systems may also consider maintaining P_MAX_voice and P_MAX_data as separate maximum transmission power limits for voice (or fixed rate traffic) and (best effort) data traffic.

For clarity purposes, the follow terminology may be utilized. P_{UE} may be the UE total transmission power. P_{UE}_{_{—}}_{voice} may be the portion of the UE transmission power for carrying voice traffic (or fixed rate traffic). P_{UE}_{_{—}}_{data} may be the portion of the UE transmission power for carrying (best effort) data traffic. P_MAX may refer to the UE maximum transmission power specified in a normal UMTS system (i.e., corresponding to the 5 MHz bandwidth defined by 3GPP standard). For example, for a given flexible bandwidth carrier system with bandwidth scaling factor of N, P_MAX_N may be defined as: P_MAX_N=P_MAX−10*log₁₀(N) in some cases. P_MAX_N may correspond to the adjustment to P_MAX with bandwidth reduction and PSD unchanged. In general, P_MAX_{—}1=P_MAX. P_MAX_voice and P_MAX_data may denote the maximum transmission power for voice and (best effort) data traffic, respectively. The power notation utilized may generally be expressed in dB domain.

Some embodiments of device 400-a and/or device 400-b may treat a first traffic type, such as voice only traffic type such that the system (both the UE and the network) may maintain the P_MAX_voice=P_MAX_N−10*log₁₀(N)=P_MAX. The UE transmission power P_{UE} (which can also be tracked by the network) may satisfy: P_{UE}=P_{UE}_{_{—}}_{voice}<P_{_{—}}_{MAX}_{_{—}}_{voice}=P_{_{—}}_{MAX}. For device 400-a and/or device 400-b as part of a base station, such as a node-B, maximum dedicated link power (which may be maintained by UTRAN, for example) may not change with respect to the bandwidth reduction, such as UMTS bandwidth reduction. The number of users on the system (not per bandwidth) may go down as the bandwidth decreases.

In some embodiments, for (e.g., best effort) data only traffic, the system (both the UE and network through device 400-a and/or device 400-b) may maintain the PSD unchanged with respect to a normal BW system, i.e., P_MAX_data=P_MAX_N. The UE transmission power P_{UE} may satisfy the condition: P_{UE}=P_{UE}_{_{—}}_{data} P_MAX_data=P_MAX−10*log₁₀(N), (in dBm), or similar formulation, where N is the bandwidth scaling factor of the flexible bandwidth system, such as flexible bandwidth carrier system. The base station (e.g., node-B) maximum dedicated link power (which may be maintained by UTRAN) may be reduced by 10*log₁₀(N) dB. In some cases, the number of users on the system may remain the same as bandwidth decreases. The peak throughput per user may go down as bandwidth decreases.

In some embodiments of device 400-a and/or device 400-b, for a mixed voice and data traffic, the system (both the UE and network) may track the power consumption for each type of traffic separately and maintains the following P_MAX_voice and P_MAX_data constraints. The total UE transmission power P_{UE} may the sum of voice power and data power, i.e. Pₗᵢₙ_{_{—}}_{UE}+Pₗᵢₙ_{_{—}}_{UE}_{_{—}}_{voice}+Pₗᵢₙ_{_{—}}_{UE}_{_{—}}_{data}, where Pₗᵢₙ_{_{—}}_{UE}, Pₗᵢₙ_{_{—}}_{UE}_{_{—}}_{voice}, and Pₗᵢₙ_{_{—}}_{UE}_{_{—}}_{data} are linear values of P_{UE}, P and P_{UE}_{_{—}}_{voice}, and P_{UE}_{_{—}}_{data}, respectively. The following three conditions may be satisfied: P_{UE}<P_MAX, P_{UE}_{_{—}}_{voice}<P_MAX_voice=P_MAX, and P_{UE}_{_{—}}_{data}<P_MAX_data=P_MAX_N=P_MAX−10*log₁₀(N). The maximum dedicated link power at the base station, such as a node-B (maintained by UTRAN), may also track the data traffic power and voice traffic power separately, and maintain a similar relationship as discussed above. The power notation the utilizes subscript “lin” may generally be expressed in linear domain.

Some embodiments of device 400-a and/or device 400-b may utilize a multi-Radio Access Bearer (multi-RAB) with circuit switched (CS) voice and packet switched (PS) data both on Dedicated Channels (DCHs). Based on uplink pilot power (i.e., the Dedicated Physical Control Channel (DPCCH) power), the UE may compute the Dedicated Physical Data Channel (DPDCH) power based on the gain factor from the rate matching parameters. Given that traffic carried on all the DCH channels may be multiplexed onto a single DPDCH channel as in existing UMTS systems, the power ratio between data and voice may be derived from the rate matching algorithm. The total power on DPDCH may go up and down following the inner loop power control. In some cases, the instantaneous transmission PSD on data may be over the limit.

For data traffic or voice and data mixed traffic, the gain factor βc and βd may be either configured by the network or computed by the UE based on the total amount of data bits (including both voice and data) to be transmitted in each radio frame. For voice traffic, for UMTS, the (pilot to traffic) amplitude ratio DPCCH/DPDCH (i.e., gain factor) may be governed by the parameters βc and βd. For 12.2 kbps Adaptive Multi-Rate (AMR) voice traffic, βc may equal 0.7333 and βd may equal 1.0 (see 3GPP TS 25.141). Therefore, the UMTS power ratio (in logarithm domain) DPCCH/DPDCH may equal −2.69 dB. In some cases, the flexible bandwidth carrier system power ratio (in logarithm domain) DPCCH/DPDCH may equal −2.69-10 log₁₀(N), where N is the bandwidth scaling factor. Therefore, for flexible bandwidth carrier system N=2, βc may equal 0.5194 and βd may equal 1.0. For flexible bandwidth carrier system N=4, βc may equal 0.3677 and βd may equal 1.0.

For data traffic or voice and data mixed traffic, the gain factor βc and βd may be either configured by the network or computed by the UE based on the total amount of data bits (including both voice and data) to be transmitted in each radio frame. Both data and voice bits may be multiplexed onto DPDCH, of which the power is determined by the gain factor βd. To determine portion of voice and data traffic power, a power consumption ratio, μ, between voice and data may be computed. One way of determining the ratio may be based on the ratio of coded data and voice bits, i.e., μ=(number of coded data traffic bits)/(number of coded voice traffic bits). The voice power may then be determined as P_{UE,voice}=P_{UE}*1/(1+μ) and the data power may be determined as P_{UE,data}=P_{UE}*μ(1+μ) for some embodiments.

To maintain P_{UE}<P_MAX, the UE may estimate the power consumption of the corresponding Transmission Time Interval (TTI) based on the computed gain factors. If the resulting average power may be higher than P_MAX, the UE may select a new Transport Format Combination Indicator (TFCI) with a smaller payload for data. For voice, the payload may generally not be reduced, but for data, less number of transport blocks may be selected. Then, on the newly selected TFCI, the UE may estimate the power consumption such that P_MAX is maintained.

To maintain P_{UE}_{_{—}}_{data}<P_MAX_data=(P_MAX−10 log₁₀ (N)), the UE may also compute average power consumption of each TTI based on the computed gain factor calculated for the (best effort) data traffic portion, i.e., P_{UE}_{_{—}}_{data}. If P_{UE}_{_{—}}_{data} may be over the limit, the UE may select again a new TFCI with reduced data traffic payload. The UE may compute again until the condition of P_{UE}_{_{—}}_{data}<P_MAX_data may be satisfied.

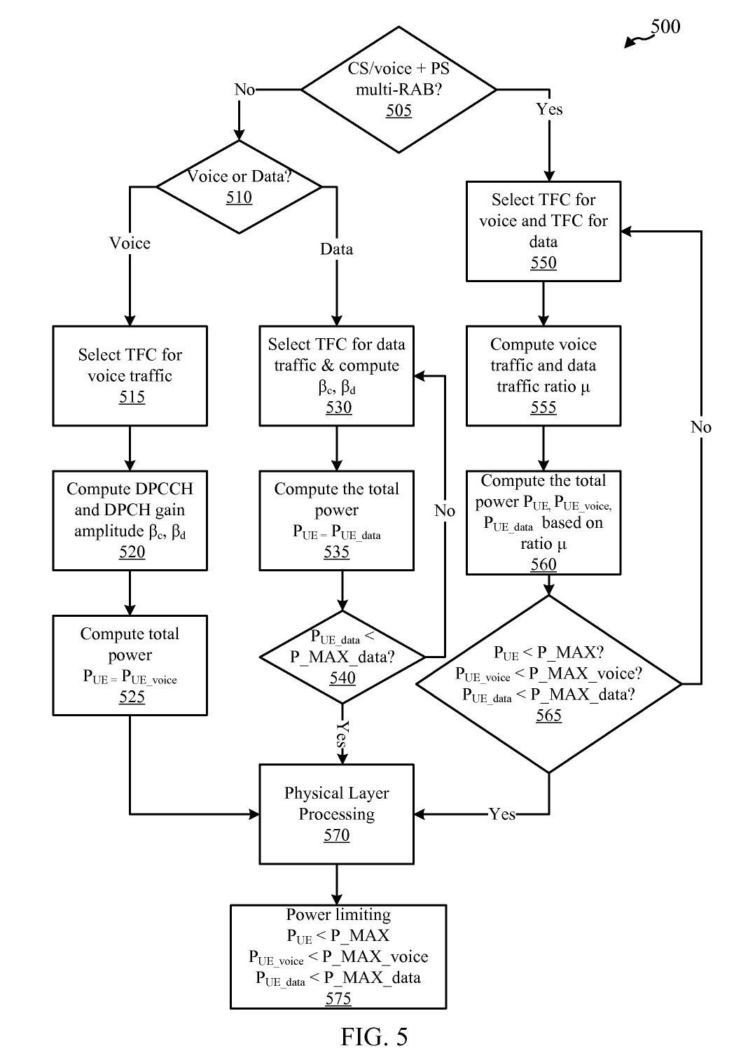

FIG. 5 shows a generic flow diagram 500 for the uplink maximum power control when both CS and PS RABs may be mapped onto DCHs. Flow diagram 500 may be implemented utilizing device 400-a and/or device 400-b. While the above discussion and figure may focus on uplink power control, similar configurations may be utilized for downlink from a base station.

At block 505, it may be determined if there is CS/voice+PS multi-RAB. If no, then at block 510, it may be determined if there is voice or data. If voice, then at block 515, TFC may be selected voice traffic. At block 520, DPCCH and DPCH gain amplitude β_{c}, β_{d} may be computed. At block 525, total power P_{UE}=P_{UE}_{_{—}}_{voice} may be computed. At block 570, physical layer processing may occur.

At block 505, it may be determined if there is CS/voice+PS multi-RAB. If no, then at block 510, it may be determined if there is voice or data. If data, then at block 530, TFC for data traffic may be selected & compute β_{c}, β_{d}. At block 535, the total power P_{UE}=P_{UE}_{_{—}}_{data} may be computed. At block 540, it may be determined whether P_{UE}_{_{—}}_{data}<P_MAX_data. If yes, then physical layer processing may occur at block 570. If no, then return to block 530.

At block 505, it may be determined if there is CS/voice+PS multi-RAB. If yes, then at block 550, TFC for voice and TFC for data may be selected. At block 555, voice traffic and data traffic ratio n may be computed. At block 560, the total power P_{UE}, P_{UE}_{_{—}}_{voice}, P_{UE}_{_{—}}_{data} based on ratio n may be computed. It may be determined at block 565 if P_{UE}<P_MAX, P_{UE}_{_{—}}_{voice}<P_MAX_voice, P_{UE}_{_{—}}_{data}<P_MAX_data. If yes, then physical layer processing at block 570 may occur. If no, then may return to block 550.

In general, after physical layer processing at block, 570, then power limiting may occur with P_{UE}<P_MAX, P_{UE}_{_{—}}_{voice}<P_MAX_voice, and P_{UE}_{_{—}}_{data}<P_MAX_data at block 575.

Some embodiments of device 400-a and/or device 400-b may utilize multi-RAB with CS voice on DCH and PS data on enhanced-DCH (E-DCH). Based on the pilot power (i.e., DPCCH power), the UE may compute the gain factor for DPDCH (onto which CS voice DCH traffic is mapped), the gain factor for E-DPCCH and E-DPDCH (onto which the PS data E-DCH is mapped). If there is HSDPA traffic on the downlink, the gain factor for HS-DPCCH may also be computed. The UE may compute P_{UE} by taking into account all the computed gain factors computed. If P_{UE}>P_MAX, the UE may select a new E-TFCI to reduce the payload on E-DCH. The UE may use the E-TFCI so that the corresponding total transmission power is below P_MAX. The UE may compute P_{UE}_{_{—}}_{data} based on the gain factors for E-DPCCH, E-DPDCH and HS-DPCCH, for example. If the resulting P_{UE}_{_{—}}_{data} is larger than P_MAX_data, the UE may select a new E-TFCI with a smaller transport block size. The UE may select a E-TFCI so that the P_{UE}_{_{—}}_{data}<P_MAX_data may be achieved.

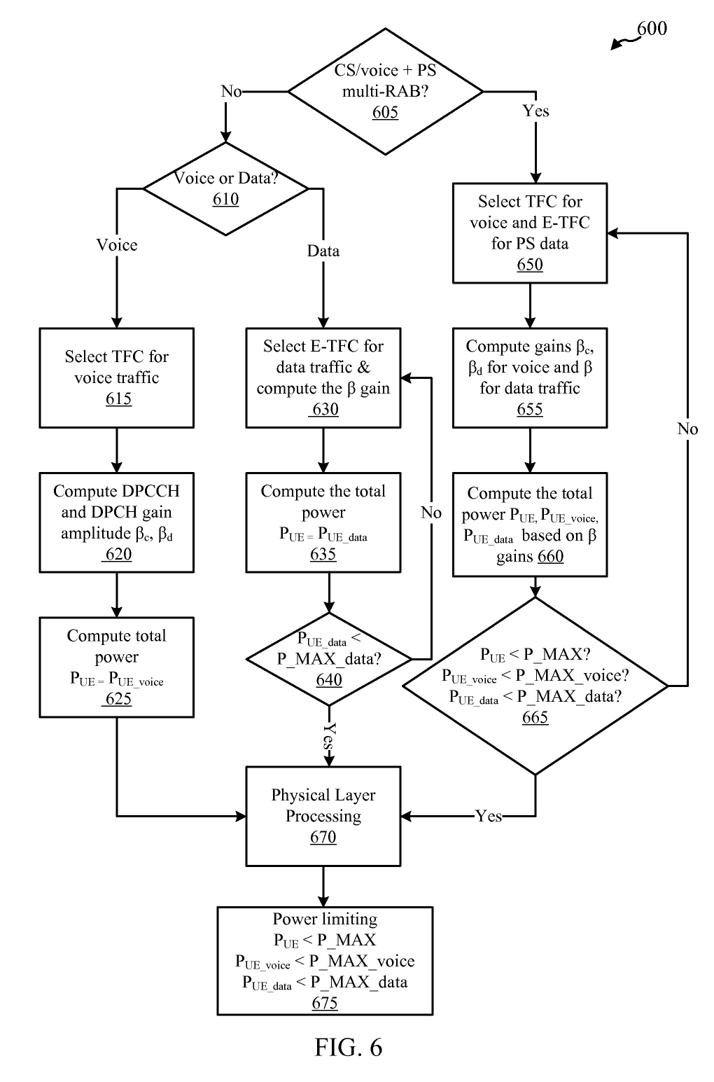

FIG. 6 illustrates a generic flow diagram 600 for the uplink maximum power control when CS is mapped on DCH and PS RAB is mapped onto E-DCH. Flow diagram 600 may be implemented utilizing device 400-a and/or device 400-b. While the above discussion and figure may focus on uplink power control, similar configurations may be utilized for downlink from a base station.

At block 605, it may be determined if there is CS/voice+PS multi-RAB. If no, then at block 610, it may be determined if there is voice or data. If voice, then at block 615, TFC may be selected voice traffic. At block 620, DPCCH and DPCH gain amplitude β_{c}, β_{d} may be computed. At block 625, total power P_{UE}=P_{UE}_{_{—}}_{voice} may be computed. At block 670, physical layer processing may occur.

At block 605, it may be determined if there is CS/voice+PS multi-RAB. If no, then at block 610, it may be determined if there is voice or data. If data, then at block 630, E-TFC for data traffic may be selected & compute β gain. At block 635, the total power P_{UE}=P_{UE}_{_{—}}_{data} may be computed. At block 640, it may be determined whether P_{UE}_{_{—}}_{data}<P_MAX_data. If yes, then physical layer processing may occur at block 670. If no, then return to block 630.

At block 605, it may be determined if there is CS/voice+PS multi-RAB. If yes, then at block 650, TFC for voice and E-TFC for PS data may be selected. At block 655, gains β_{c}, β_{d} for voice and β for data traffic may be computed. At block 660, the total power P_{UE}, P_{UE}_{_{—}}_{voice}, P_{UE}_{_{—}}_{data} based on 13 gains may be computed. It may be determined at block 665 if P_{UE}<P_MAX, P_{UE}_{_{—}}_{voice}<P_MAX_voice, P_{UE}_{_{—}}_{data}<, P_MAX_data. If yes, then physical layer processing at block 670 may occur. If no, then may return to block 650.

In general, after physical layer processing at block 670, then power limiting may occur with P_{UE}<P_MAX, P_{UE}_{_{—}}_{voice}<P_MAX_voice, and P_{UE}_{_{—}}_{data}<P_MAX_data at block 675.

The embodiments of device 400-a and/or device 400-b described above provide the principle of maximum power control that may achieve the balance between coverage and interference control. The following embodiment gives one way of interpreting the principle. The same principle can be applied (or modified then applied) to many other scenarios for achieving optimal coverage and interference management. The following is an example of variations. For example, with VOIP traffic or voice over HSPA (VoHS), the voice traffic may be mapped onto high speed packet data bearer. In particular, on uplink, both voice and data may be be mapped to E-DCH channel. In such a case, for a mixed voice and data traffic, The total UE transmission power P_{UE} may be: Pₗᵢₙ_{_{—}}_{UE}=Pₗᵢₙ_{_{—}}_{UE}_{_{—}}_{VoHS}+Pₗᵢₙ_{_{—}}_{UE}_{_{—}}_{HSdata}, where P_{UE}_{_{—}}_{VoHS} may be the power for carrying voice over E-DCH channel (which may be normally characterized as a non-scheduled traffic), and P_{UE}_{_{—}}_{HSdata} may be the power for carrying (best effort) data over E-DCH (which may be normally characterized as a scheduled traffic). The following constraints may also be utilized: P_{UE}<P_MAX; P_{UE}_{_{—}}_{VoHS}<P_MAX_voice=P_MAX; and/or P_{UE}_{_{—}}_{HSdata}<P_{_{—}}_{MAX}_{_{—}}_{data}=P_MAX_N=P_MAX−10*log₁₀(N).

Some embodiments utilize separate P_MAX settings for different type of traffic, such as voice and data traffic. The P_MAX settings may be determined on the network side, such as at a core network, a controller, and/or a base station. For fixed data rate services (such as voice traffic), the transmission power may be limited by P_MAX_voice. For best effort data traffic, the transmission power may be limited by P_MAX_data. Both P_MAX_voice and P_MAX_data may be determined and signaled by the network to the UE to limit the uplink transmission power. The network operator, for example, may pick proper P_MAX_voice and P_MAX_data based on proper consideration and balance of the coverage, interference level, and/or capacity of the system, for example. Also the UE may compute the default P_MAX_voice and P_MAX_data based on the P_MAX and N, such as, using the relationships described above. The UE may maintain P_{UE}_{_{—}}_{voice}<P_MAX_voice, and P_{UE}_{_{—}}_{data}<P_MAX_data. The total UE transmission power may be P_{UE}, the sum of the transmission power for voice and data i.e., Pₗᵢₙ_{_{—}}_{UE}=Pₗᵢₙ_{_{—}}_{UE,voice}+Pₗᵢₙ_{_{—}}_{UE,data}. To compute the voice or data transmission power, the tools and techniques describe above may be applicable with respect to these embodiments. In some cases, P_{UE} may be limited by P_MAX as described above.

Some embodiments of device 400-a and/or device 400-b may balance interference, coverage, and capacity in the system. Different approaches of limiting the UE transmission power, either limiting by maintaining the same PSD, or limiting by maintain the same P_MAX, may have different effects on interference, coverage, and cell capacity. For the same reason, the selection of P_MAX_voice and P_MAX_data may also be taken into account the balance between interference, coverage, and capacity. Generally speaking, there may be a cost function C, which may be written as:

C=K1*cap(P_MAX_voice,P_MAX_data)+K2*cov(P_MAX_voice,P_MAX_data),

where cap(.) and cov(.) may be the functions measuring the capacity and coverage in the system, and K1 and K2 may be weighting factors, depending on the network operation objective. Then, the proper value of P_MAX_voice and P_MAX_data may be the ones that achieves:

Max{P_MAX_voice,P_MAX_data}(C), while int(P_MAX_voice,P_MAX_data)<K0,

where the function int(.) may be the interference measurement, and K0 may be the interference limit.

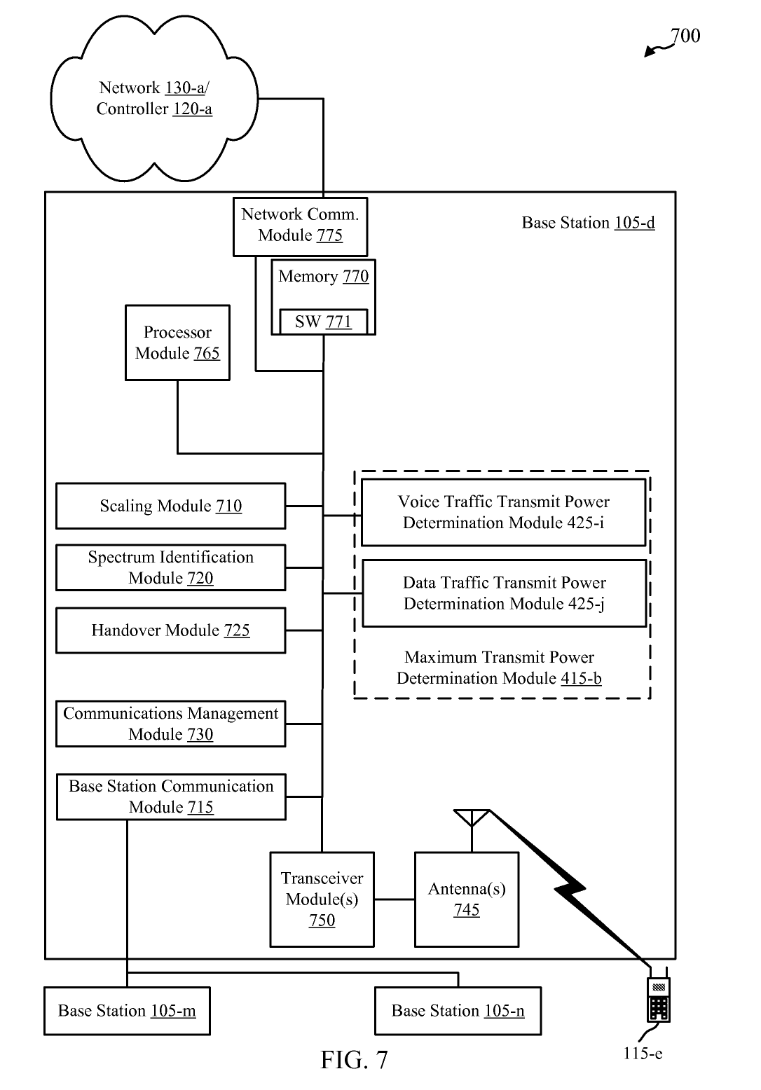

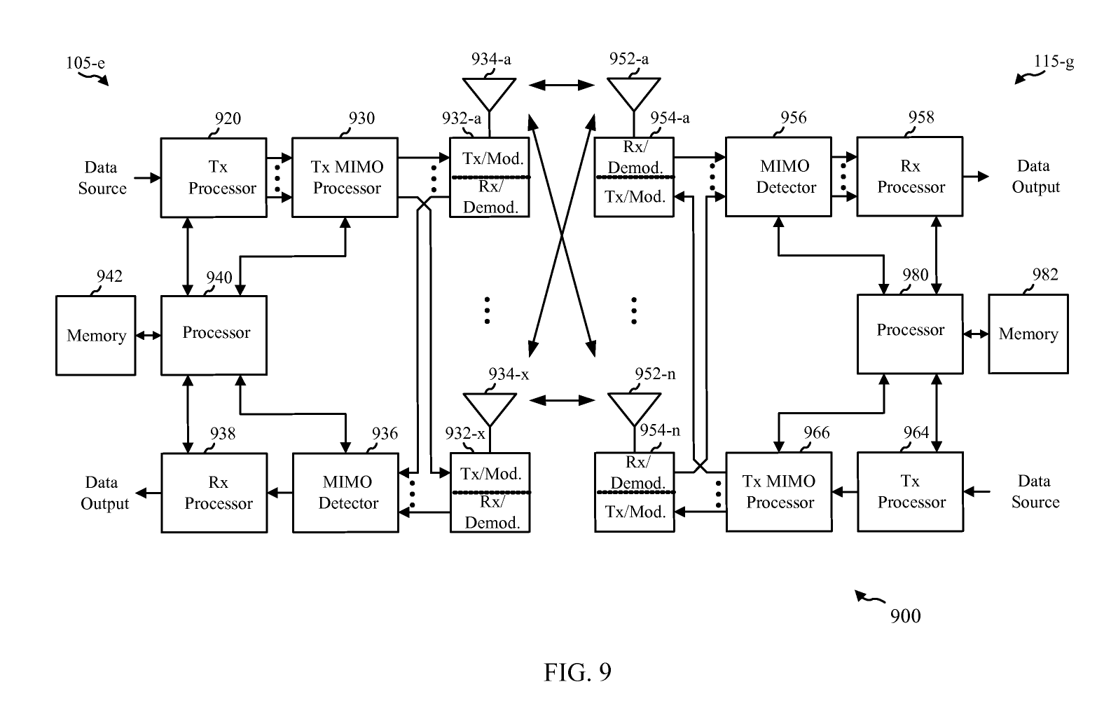

FIG. 7 shows a block diagram of a wireless communications system 700 in accordance with various embodiments. This system 700 may be an example of aspects of the system 100 depicted in FIG. 1, systems 200 of FIG. 2, system 300 of FIG. 3, and/or system 900 of FIG. 9. The base station 105-d may include antennas 745, a transceiver module 750, memory 770, and a processor module 965, which each may be in communication, directly or indirectly, with each other (e.g., over one or more buses). The transceiver module 750 may be configured to communicate bi-directionally, via the antennas 745, with the user equipment 115-e, which may be a multi-mode user equipment. The transceiver module 750 (and/or other components of the base station 105-d) may also be configured to communicate bi-directionally with one or more networks. In some cases, the base station 105-d may communicate with the network 130-a and/or controller 110-a through network communications module 775. Base station 105-d may be an example of an eNodeB base station, a Home eNodeB base station, a NodeB base station, and/or a Home NodeB base station. Controller 110-a may be integrated into base station 105-d in some cases, such as with an eNodeB base station.

Base station 105-d may also communicate with other base stations 105, such as base station 105-m and base station 105-n. Each of the base stations 105 may communicate with user equipment 115-e using different wireless communications technologies, such as different Radio Access Technologies. In some cases, base station 105-d may communicate with other base stations such as 105-m and/or 105-n utilizing base station communication module 715. In some embodiments, base station communication module 715 may provide an X2 interface within an LTE wireless communication technology to provide communication between some of the base stations 105. In some embodiments, base station 105-d may communicate with other base stations through controller 110-a and/or network 130-a.

The memory 770 may include random access memory (RAM) and read-only memory (ROM). The memory 770 may also store computer-readable, computer-executable software code 771 containing instructions that are configured to, when executed, cause the processor module 765 to perform various functions described herein (e.g., call processing, database management, message routing, etc.). Alternatively, the software code 771 may not be directly executable by the processor module 765 but be configured to cause the computer, e.g., when compiled and executed, to perform functions described herein.

The processor module 765 may include an intelligent hardware device, e.g., a central processing unit (CPU) such as those made by Intel® Corporation or AMD®, a microcontroller, an application-specific integrated circuit (ASIC), etc. The processor module 765 may include a speech encoder (not shown) configured to receive audio via a microphone, convert the audio into packets (e.g., 20 ms in length) representative of the received audio, provide the audio packets to the transceiver module 750, and provide indications of whether a user is speaking. Alternatively, an encoder may only provide packets to the transceiver module 750, with the provision or withholding/suppression of the packet itself providing the indication of whether a user is speaking.

The transceiver module 750 may include a modem configured to modulate the packets and provide the modulated packets to the antennas 745 for transmission, and to demodulate packets received from the antennas 745. While some examples of the base station 105-d may include a single antenna 745, the base station 105-d preferably includes multiple antennas 745 for multiple links which may support carrier aggregation. For example, one or more links may be used to support macro communications with user equipment 115-e.

According to the architecture of FIG. 7, the base station 105-d may further include a communications management module 730. The communications management module 730 may manage communications with other base stations 105. By way of example, the communications management module 730 may be a component of the base station 105-d in communication with some or all of the other components of the base station 105-d via a bus. Alternatively, functionality of the communications management module 730 may be implemented as a component of the transceiver module 750, as a computer program product, and/or as one or more controller elements of the processor module 765.

The components for base station 105-d may be configured to implement aspects discussed above with respect to device 400-a in FIG. 4A and/or device 400-b of FIG. 4B and may not be repeated here for the sake of brevity. For example, the maximum transmit power determination module 415-b may be example of the maximum transmit power determination module 415 of FIG. 4A and/or the maximum transmit power determination module 415-a of FIG. 4B. The voice traffic transmit power determination module 425-i and/or the data traffic transmit power determination module 425-j may be examples of the traffic transmit power determination modules 425-a, . . . 425-n of FIG. 4B.

The base station 105-d may also include a spectrum identification module 720. The spectrum identification module 720 may be utilized to identify spectrum available for flexible waveforms. In some embodiments, a handover module 725 may be utilized to perform handover procedures of the user equipment 115-e from one base station 105 to another. For example, the handover module 725 may perform a handover procedure of the user equipment 115-e from base station 105-d to another where normal waveforms are utilized between the user equipment 115-e and one of the base stations and flexible waveforms are utilized between the user equipment and another base station. A scaling module 710 may be utilized to scale and/or alter chip rates to generate flexible waveforms.

In some embodiments, the transceiver module 750 in conjunction with antennas 745, along with other possible components of base station 105-d, may transmit information regarding flexible waveforms and/or scaling factors from the base station 105-d to the user equipment 115-e, to other base stations 105-m/105-n, or core network 130-a. In some embodiments, the transceiver module 750 in conjunction with antennas 745, along with other possible components of base station 105-d, may transmit information to the user equipment 115-e, to other base stations 105-m/105-n, or core network 130-a, such as flexible waveforms and/or scaling factors, such that these devices or systems may utilize flexible waveforms.

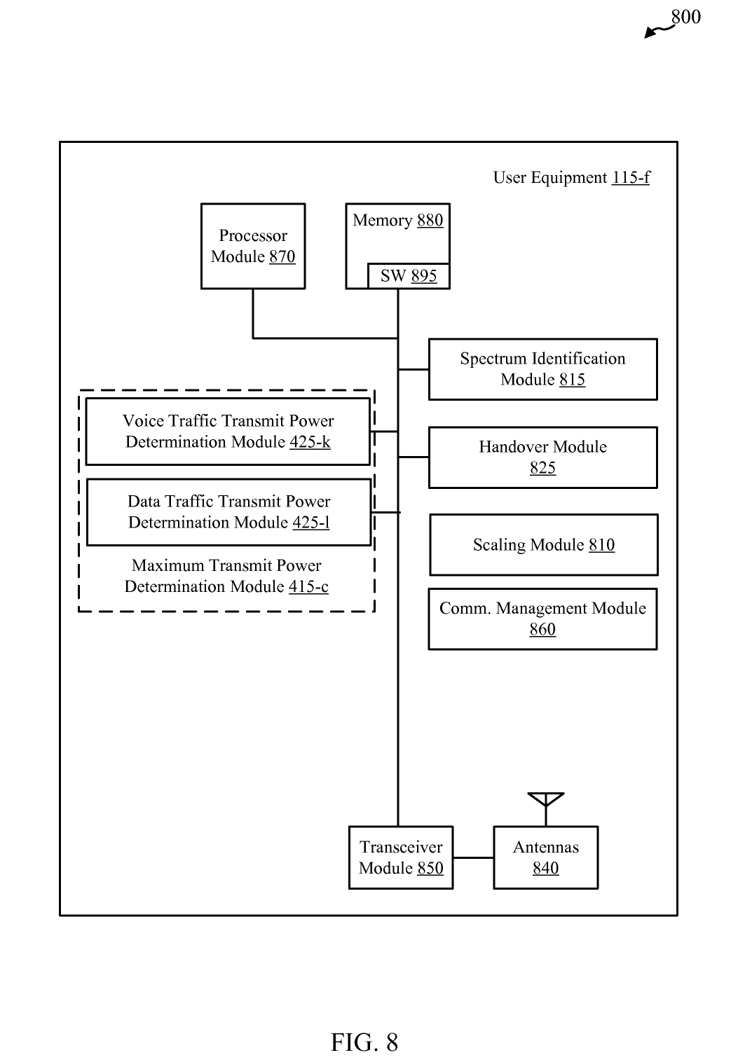

FIG. 8 is a block diagram 800 of a user equipment 115-f in accordance with various embodiments. The user equipment 115-f may have any of various configurations, such as personal computers (e.g., laptop computers, netbook computers, tablet computers, etc.), cellular telephones, PDAs, digital video recorders (DVRs), internet appliances, gaming consoles, e-readers, etc. The user equipment 115-f may have an internal power supply (not shown), such as a small battery, to facilitate mobile operation. In some embodiments, the user equipment 115-f may be the user equipment 115 of FIG. 1, FIG. 2, FIG. 3, FIG. 7, and/or FIG. 9, and/or the device 400-a of FIG. 4a and/or device 400-b of FIG. 4B. The user equipment 115-f may be a multi-mode user equipment. The user equipment 115-f may be referred to as a wireless communications device in some cases.

The user equipment 115-f may include antennas 840, a transceiver module 850, memory 880, and a processor module 870, which each may be in communication, directly or indirectly, with each other (e.g., via one or more buses). The transceiver module 850 is configured to communicate bi-directionally, via the antennas 840 and/or one or more wired or wireless links, with one or more networks, as described above. For example, the transceiver module 850 may be configured to communicate bi-directionally with base stations 105 of FIG. 1, FIG. 2, FIG. 3, FIG. 7, and/or FIG. 9. The transceiver module 850 may include a modem configured to modulate the packets and provide the modulated packets to the antennas 840 for transmission, and to demodulate packets received from the antennas 840. While the user equipment 115-f may include a single antenna, the user equipment 115-f will typically include multiple antennas 840 for multiple links.

The memory 880 may include random access memory (RAM) and read-only memory (ROM). The memory 880 may store computer-readable, computer-executable software code 895 containing instructions that are configured to, when executed, cause the processor module 870 to perform various functions described herein (e.g., call processing, database management, message routing, etc.). Alternatively, the software 895 may not be directly executable by the processor module 870 but be configured to cause the computer (e.g., when compiled and executed) to perform functions described herein.

The processor module 870 may include an intelligent hardware device, e.g., a central processing unit (CPU) such as those made by Intel® Corporation or AMD®, a microcontroller, an application-specific integrated circuit (ASIC), etc. The processor module 870 may include a speech encoder (not shown) configured to receive audio via a microphone, convert the audio into packets (e.g., 20 ms in length) representative of the received audio, provide the audio packets to the transceiver module 850, and provide indications of whether a user is speaking. Alternatively, an encoder may only provide packets to the transceiver module 850, with the provision or withholding/suppression of the packet itself providing the indication of whether a user is speaking.

According to the architecture of FIG. 8, the user equipment 115-f may further include a communications management module 860. The communications management module 860 may manage communications with other user equipment 115. By way of example, the communications management module 860 may be a component of the user equipment 115-f in communication with some or all of the other components of the user equipment 115-f via a bus. Alternatively, functionality of the communications management module 860 may be implemented as a component of the transceiver module 850, as a computer program product, and/or as one or more controller elements of the processor module 870.

The components for user equipment 115-f may be configured to implement aspects discussed above with respect to device 400-a in FIG. 4A and/or device 400-b of FIG. 4B and may not be repeated here for the sake of brevity. For example, the maximum transmit power determination module 415-c may be example of the maximum transmit power determination module 415 of FIG. 4A and/or the maximum transmit power determination module 415-a of FIG. 4B. The voice traffic transmit power determination module 425-k and/or the data traffic transmit power determination module 425-1 may be examples of the traffic transmit power determination modules 425-a, . . . 425-n of FIG. 4B.

The user equipment 115-f may also include a spectrum identification module 815. The spectrum identification module 815 may be utilized to identify spectrum available for flexible waveforms. In some embodiments, a handover module 825 may be utilized to perform handover procedures of the user equipment 115-f from one base station to another. For example, the handover module 825 may perform a handover procedure of the user equipment 115-f from one base station to another where normal waveforms are utilized between the user equipment 115-f and one of the base stations and flexible waveforms are utilized between the user equipment and another base station. A scaling module 810 may be utilized to scale and/or alter chip rates to generate flexible waveforms.

In some embodiments, the transceiver module 850 in conjunction with antennas 840, along with other possible components of user equipment 115-f, may transmit information regarding flexible waveforms and/or scaling factors from the user equipment 115-f to base stations or a core network. In some embodiments, the transceiver module 850, in conjunction with antennas 840 along with other possible components of user equipment 115-f, may transmit information, such as flexible waveforms and/or scaling factors, to base stations or a core network such that these devices or systems may utilize flexible waveforms.

FIG. 9 is a block diagram of a system 900 including a base station 105-e and a user equipment 115-g in accordance with various embodiments. This system 900 may be an example of the system 100 of FIG. 1, systems 200 of FIG. 2, system 300 of FIG. 3, and/or system 700 of FIG. 7. The base station 105-e may be equipped with antennas 934-a through 934-x, and the user equipment 115-g may be equipped with antennas 952-a through 952-n. At the base station 105-e, a transmitter processor 920 may receive data from a data source. Base stations 105-e and/or user equipment 115-g may implement aspects of device 400-a of FIG. 4A and/or device 400-b of FIG. 4B. User equipment 115-g may be an example of user equipment 115-f of FIG. 9.

The transmitter processor 920 may process the data. The transmitter processor 920 may also generate reference symbols, and a cell-specific reference signal. A transmit (TX) MIMO processor 930 may perform spatial processing (e.g., precoding) on data symbols, control symbols, and/or reference symbols, if applicable, and may provide output symbol streams to the transmit modulators 932-a through 932-x. Each modulator 932 may process a respective output symbol stream (e.g., for OFDM, etc.) to obtain an output sample stream. Each modulator 932 may further process (e.g., convert to analog, amplify, filter, and upconvert) the output sample stream to obtain a downlink (DL) signal. In one example, DL signals from modulators 932-a through 932-x may be transmitted via the antennas 934-a through 934-x, respectively. The transmitter processor 920 may receive information from a processor 940. The processor 940 may be configured to generate flexible waveforms through altering a chip rate and/or utilizing a scaling factor; this may be done dynamically in some cases. The processor 940 may also provide for different alignment and/or offsetting procedures. The processor 940 may also utilize scaling and/or chip rate information to perform measurements on the other subsystems, perform handoffs to the other subsystems, perform reselection, etc. The processor 940 may invert the effects of time stretching associated with the use of flexible bandwidth through parameter scaling. In some embodiments, the processor 940 may be implemented as part of a general processor, the transmitter processor 920, and/or the receiver processor 938. The processor 940 may be coupled with a memory 942.

In some embodiments, processor 940 and/or Tx processor 920 are configured to configure maximum allowed transmit power for aspects of system 900. In some embodiments, processor 940 and/or Tx processor 920 are configured to identify multiple traffic types. In some embodiments, processor 940 and/or Tx processor 920 are configured to treat the multiple traffic types separately with respect to one or more maximum allowed transmit power limits. The multiple traffic types may include a voice traffic and a data traffic.

In some embodiments, processor 940 and/or Tx processor 920 are configured to determine at least first transmit power limit for at least a first traffic type may occur and/or determining at least a second transmit power limit for at least a second traffic type. In some embodiments, processor 940 and/or Tx processor 920 are configured to utilizing at least the first transmit power limit with respect to the first traffic type or the second transmit power limit with respect to the second traffic type. The first traffic type may include a voice traffic and the second traffic type includes at least a data traffic.

In some embodiments, processor 940 and/or Tx processor 920 are configured to transmitting and/or receiving the one or more transmit power limits. The first transmit power limit may include a maximum total transmit power. The second transmit power limit may include a maximum scaled transmit power. The maximum scaled transmit power may maintain a fixed power spectrum density (PSD) with respect to a normal bandwidth system. In some cases, the maximum scaled transmit power may be maintained with respect to another fixed PSD that may not be associated with a normal bandwidth carrier system. The maximum total scaled transmit power may be scaled logarithmically with a bandwidth scaling factor of a flexible bandwidth carrier system. For example, the maximum total scaled transmit power may equal a maximum total transmit power minus floor (10 Log₁₀) N), where N equals the bandwidth scaling factor of the flexible bandwidth carrier system. In some embodiments, processor 940 and/or Tx processor 920 are part of a flexible bandwidth carrier system.

At the user equipment 115-g, the user equipment antennas 952-a through 952-n may receive the DL signals from the base station 105-e and may provide the received signals to the demodulators 954-a through 954-n, respectively. Each demodulator 954 may condition (e.g., filter, amplify, downconvert, and digitize) a respective received signal to obtain input samples. Each demodulator 954 may further process the input samples (e.g., for OFDM, etc.) to obtain received symbols. A MIMO detector 956 may obtain received symbols from all the demodulators 954-a through 954-n, perform MIMO detection on the received symbols if applicable, and provide detected symbols. A receive processor 958 may process (e.g., demodulate, deinterleave, and decode) the detected symbols, providing decoded data for the user equipment 115-g to a data output, and provide decoded control information to a processor 980, or memory 982.

On the uplink (UL), at the user equipment 115-g, a transmitter processor 964 may receive and process data from a data source. The transmitter processor 964 may also generate reference symbols for a reference signal. The symbols from the transmitter processor 964 may be precoded by a transmit MIMO processor 966 if applicable, further processed by the demodulators 954-a through 954-n (e.g., for SC-FDMA, etc.), and be transmitted to the base station 105-e in accordance with the transmission parameters received from the base station 105-e. The transmitter processor 964 may also be configured to generate flexible waveforms through altering a chip rate and/or utilizing a scaling factor; this may be done dynamically in some cases. The transmitter processor 964 may receive information from processor 980. The processor 980 may provide for different alignment and/or offsetting procedures. The processor 980 may also utilize scaling and/or chip rate information to perform measurements on the other subsystems, perform handoffs to the other subsystems, perform reselection, etc. The processor 980 may invert the effects of time stretching associated with the use of flexible bandwidth through parameter scaling. At the base station 105-e, the UL signals from the user equipment 115-g may be received by the antennas 934, processed by the demodulators 932, detected by a MIMO detector 936 if applicable, and further processed by a receive processor. The receive processor 938 may provide decoded data to a data output and to the processor 980. In some embodiments, the processor 980 may be implemented as part of a general processor, the transmitter processor 964, and/or the receiver processor 958.

In some embodiments, processor 980 and/or Tx processor 964 are configured to configure maximum allowed transmit power for aspects of system 900. In some embodiments, processor 980 and/or Tx processor 964 are configured to identify multiple traffic types. In some embodiments, processor 980 and/or Tx processor 964 are configured to treat the multiple traffic types separately with respect to one or more maximum allowed transmit power limits. The multiple traffic types may include a voice traffic and a data traffic.

In some embodiments, processor 980 and/or Tx processor 964 are configured to determine at least first transmit power limit for at least a first traffic type may occur and/or determining at least a second transmit power limit for at least a second traffic type. In some embodiments, processor 980 and/or Tx processor 964 are configured to utilizing at least the first transmit power limit with respect to the first traffic type or the second transmit power limit with respect to the second traffic type. The first traffic type may include a voice traffic and the second traffic type includes at least a data traffic.

In some embodiments, processor 980 and/or Tx processor 964 are configured to transmitting and/or receiving the one or more transmit power limits. The first transmit power limit may include a maximum total transmit power. The second transmit power limit may include a maximum scaled transmit power. The maximum scaled transmit power may maintain a fixed power spectrum density (PSD) with respect to a normal bandwidth system. In some cases, the maximum scaled transmit power may be maintained with respect to another fixed PSD that may not be associated with a normal bandwidth carrier system. The maximum total scaled transmit power may be scaled logarithmically with a bandwidth scaling factor of a flexible bandwidth carrier system. For example, the maximum total scaled transmit power may equal a maximum total transmit power minus floor (10 Log₁₀ N), where N equals the bandwidth scaling factor of the flexible bandwidth carrier system. In some embodiments, processor 980 and/or Tx processor 964 are part of a flexible bandwidth carrier system.

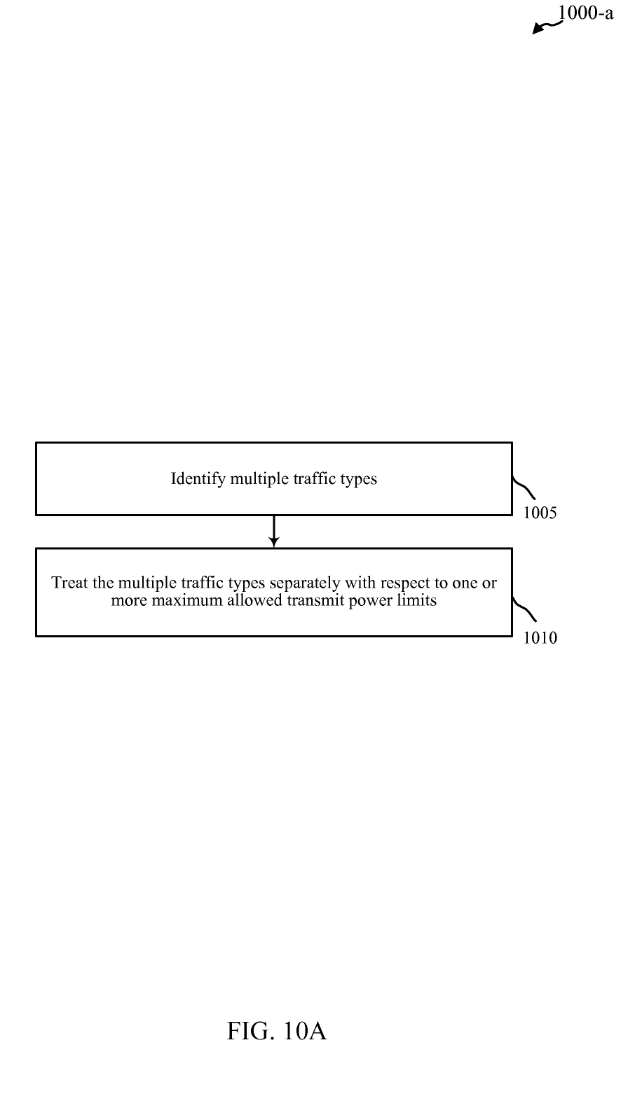

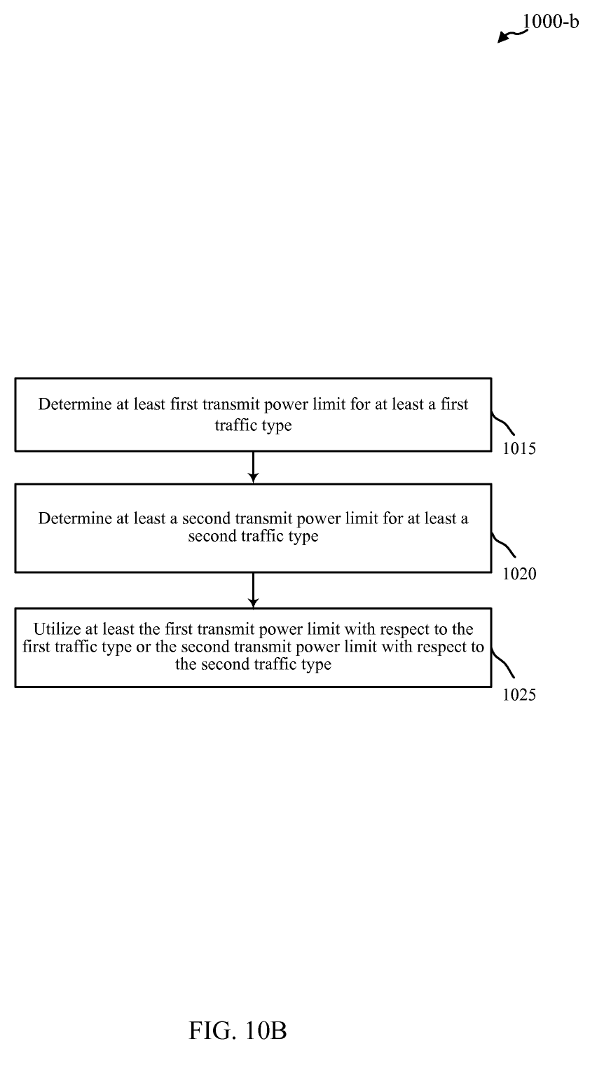

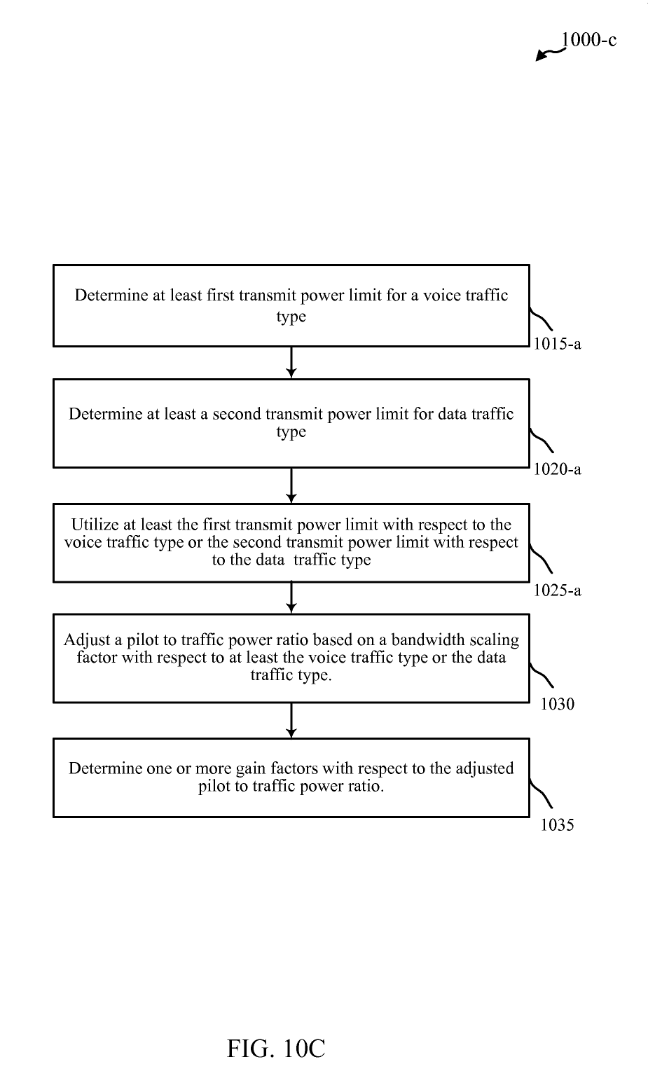

Turning to FIG. 10A, a flow diagram of a method 1000-a of configuring maximum allowed transmit power for a wireless communications system. Method 1000-a may be implemented utilizing various wireless communications devices including, but not limited to: a base station 105 as seen in FIG. 1, FIG. 2, FIG. 3, FIG. 7, and/or FIG. 9; and/or device 400-a as seen in FIG. 4A and/or device 400-b of FIG. 4B. In some embodiments, method 1000-a may be implemented utilizing various wireless communications devices including, but not limited to: a user equipment 115 as seen in FIG. 1, FIG. 2, FIG. 3, FIG. 7, FIG. 10, and/or FIG. 9. Method 1000-a may also implement aspects of method 1000-b of FIG. 10B. In some cases, aspects of method 1000-a may be implemented by core network 130 and/or controller 120 of FIG. 1 and/or FIG. 7.

Identifying multiple traffic types may occur at block 1005. Treating the multiple traffic types separately with respect to one or more maximum allowed transmit power limits may occur at block 1010. The multiple traffic types may include a voice traffic and a data traffic.

Turning to FIG. 10B, a flow diagram of a method 1000-b of configuring maximum allowed transmit power for a wireless communications system. Method 1000-b may be implemented utilizing various wireless communications devices including, but not limited to: a base station 105 as seen in FIG. 1, FIG. 2, FIG. 3, FIG. 7, and/or FIG. 9; and/or device 400-a as seen in FIG. 4A and/or device 400-b of FIG. 4B. In some embodiments, method 1000-b may be implemented utilizing various wireless communications devices including, but not limited to: a user equipment 115 as seen in FIG. 1, FIG. 2, FIG. 3, FIG. 7, FIG. 10, and/or FIG. 9. Method 1000-b may also implement aspects of method 1000-a of FIG. 10A. In some cases, aspects of method 1000-b may be implemented by core network 130 and/or controller 120 of FIG. 1 and/or FIG. 7.

Determining at least first transmit power limit for at least a first traffic type may occur at block 1015. Determining at least a second transmit power limit for at least a second traffic type may occur at block 1020. Utilizing at least the first transmit power limit with respect to the first traffic type or the second transmit power limit with respect to the second traffic type may occur at block 1025. The first traffic type may include a voice traffic and the second traffic type includes at least a data traffic.

Some embodiments transmitting and/or receiving the one or more transmit power limits. The first transmit power limit may include a maximum total transmit power. The second transmit power limit may include a maximum scaled transmit power. The maximum scaled transmit power may maintain a fixed power spectrum density (PSD) with respect to a normal bandwidth system. The maximum total scaled transmit power may be scaled logarithmically with a bandwidth scaling factor of a flexible bandwidth carrier system. For example, the maximum total scaled transmit power may equal a maximum total transmit power minus floor (10 Log₁₀ N), where N equals the bandwidth scaling factor of the flexible bandwidth carrier system. Some embodiments include adjusting a pilot to traffic power ratio based on a bandwidth scaling factor. Some embodiments include determining one or more gain factors with respect to the adjusted pilot to traffic power ratio.

In some embodiment, a base station determines at least the first transmit power limit or the second transmit power limit and transmits them to one or more user equipment. In some embodiments, a user equipment determines at least the first transmit power limit or the second transmit power limit with respect to a maximum total transmit power. The wireless communications system may include a flexible bandwidth carrier system.

In some embodiments, the first traffic type includes a voice service. In some embodiments, at least the first traffic type or the second traffic type includes a data service. In some embodiments, the first traffic type and the second traffic type utilize different carriers.

In some embodiments, the wireless communications system includes at least a multi-carrier system or a multi-cell system.

Turning to FIG. 10C, a flow diagram of a method 1000-c of configuring maximum allowed transmit power for a wireless communications system. Method 1000-c may be implemented utilizing various wireless communications devices including, but not limited to: a base station 105 as seen in FIG. 1, FIG. 2, FIG. 3, FIG. 7, and/or FIG. 9; and/or device 400-a as seen in FIG. 4A and/or device 400-b of FIG. 4B. In some embodiments, method 1000-b may be implemented utilizing various wireless communications devices including, but not limited to: a user equipment 115 as seen in FIG. 1, FIG. 2, FIG. 3, FIG. 7, FIG. 10, and/or FIG. 9. Method 1000-c may also implement aspects of method 1000-a of FIG. 10A. In some cases, aspects of method 1000-c may be implemented by core network 130 and/or controller 120 of FIG. 1 and/or FIG. 7.

Determining at least first transmit power limit for a voice traffic type may occur at block 1015-a. Determining at least a second transmit power limit for a data traffic type may occur at block 1020-a. Utilizing at least the first transmit power limit with respect to the voice traffic type or the second transmit power limit with respect to the data traffic type may occur at block 1025-a. At block 1030, a pilot to traffic power ratio may be adjusted based on a bandwidth scaling factor with respect to at least the voice traffic type or the data traffic type. At block 1035, one or more gain factors may be determined with respect to the adjusted pilot to traffic power ratio.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general-purpose or special-purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of configuring maximum allowed transmit power for a wireless communications system, the method comprising:
determining at least first transmit power limit for at least a first traffic type;
determining at least a second transmit power limit for at least a second traffic type; and
utilizing at least the first transmit power limit with respect to the first traffic type or the second transmit power limit with respect to the second traffic type.

2. The method of claim 1, wherein the first traffic type includes a voice traffic type and the second traffic type includes at least a data traffic type.

3. The method of claim 1, further comprising:
adjusting a pilot to traffic power ratio based on a bandwidth scaling factor of the wireless communication system.

4. The method of claim 3, further comprising:
determining one or more gain factors with respect to the adjusted pilot to traffic power ratio; and
utilizing the one or more gain factors with respect to the adjusted pilot to traffic power ratio.

5. The method of claim 1, further comprising:
transmitting the two or more transmit power limits.

6. The method of claim 1, further comprising:
receiving the two or more transmit power limits.

7. The method of claim 1, wherein the first transmit power limit includes a maximum total transmit power.

8. The method of claim 1, wherein at least second transmit power limit includes a maximum total scaled transmit power.

9. The method of claim 8, where the maximum scaled transmit power maintains a fixed power spectrum density (PSD) with respect to a normal bandwidth system.

10. The method of claim 8, wherein the maximum total scaled transmit power scales logarithmically with a bandwidth scaling factor of a flexible bandwidth carrier system.

11. The method of claim 10, wherein the maximum total scaled transmit power equals a maximum total transmit power minus floor (10 Log₁₀ N), where N equals the bandwidth scaling factor of the flexible bandwidth carrier system.

12. The method of claim 1, wherein a base station determines at least the first transmit power limit or the second transmit power limit and transmits them to one or more user equipment.

13. The method of claim 1, wherein a user equipment determines at least the first transmit power limit or the second transmit power limit with respect to a maximum total transmit power.

14. The method of claim 1, wherein the wireless communications system includes a flexible bandwidth carrier system.

15. The method of claim 1, wherein the first traffic type includes a voice service.

16. The method of claim 1, wherein at least the first traffic type or the second traffic type includes a data service.

17. The method of claim 1, wherein the first traffic type and the second traffic type utilize different carriers.

18. The method of claim 1, wherein the wireless communications system includes at least a multi-carrier system or a multi-cell system.

19. A wireless communications system for configuring maximum allowed transmit power, the system comprising:
means for determining at least first transmit power limit for at least a first traffic type;
means for determining at least a second transmit power limit for at least a second traffic type; and
means for utilizing at least the first transmit power limit with respect to the first traffic type or the second transmit power limit with respect to the second traffic type.

20. The wireless communications system of claim 19, wherein the first traffic type includes a voice traffic type and the second traffic type includes at least a data traffic type.

21. The wireless communications system of claim 19, further comprising:
means for transmitting the one or more transmit power limits.

22. The wireless communications system of claim 19, further comprising:
means for receiving the one or more transmit power limits.

23. The wireless communications system of claim 19, where in the first transmit power limit includes a maximum total transmit power.

24. The wireless communications system of claim 19, wherein at least second transmit power limit includes a maximum total scaled transmit power.

25. The wireless communications system of claim 24, wherein the maximum scaled transmit power maintains a fixed power spectrum density (PSD) with respect to a normal bandwidth system.

26. The wireless communications system of claim 24, wherein the maximum total scaled transmit power scales logarithmically with a bandwidth scaling factor of a flexible bandwidth carrier system.

27. The wireless communications system of claim 26, wherein the maximum total scaled transmit power equals a maximum total transmit power minus floor (10 Log₁₀) N), where N equals the bandwidth scaling factor of the flexible bandwidth carrier system.

28. The wireless communications system of claim 19, wherein a base station determines at least the first transmit power limit or the second transmit power limit and transmits them to one or more user equipment.

29. The wireless communications system of claim 19, further comprising:
means for adjusting a pilot to traffic power ratio based on a bandwidth scaling factor.

30. The wireless communications system of claim 29, further comprising:
means for determining one or more gain factors with respect to the adjusted pilot to traffic power ratio.

31. The wireless communications system of claim 19, wherein a user equipment determines at least the first transmit power limit or the second transmit power limit with respect to a maximum total transmit power.

32. The wireless communications system of claim 19, wherein the wireless communications system includes a flexible bandwidth carrier system.

33. A computer program product for configuring maximum allowed transmit power for a wireless communications system comprising:
a non-transitory computer-readable medium comprising:
code for determining at least first transmit power limit for at least a first traffic type;
code for determining at least a second transmit power limit for at least a second traffic type; and
code for utilizing at least the first transmit power limit with respect to the first traffic type or the second transmit power limit with respect to the second traffic type.

34. The computer program product of claim 33, wherein the first traffic type includes a voice traffic type and the second traffic type includes at least a data traffic type.

35. The computer program product of claim 33, further comprising:
code for transmitting the one or more transmit power limits.

36. The computer program product of claim 33, further comprising:
code for receiving the one or more transmit power limits.

37. The computer program product of claim 33, wherein the first transmit power limit includes a maximum total transmit power.

38. The computer program product of claim 33, wherein at least second transmit power limit includes a maximum total scaled transmit power.

39. The computer program product of claim 38, wherein the maximum scaled transmit power maintains a fixed power spectrum density (PSD) with respect to a normal bandwidth system.

40. The computer program product of claim 38, wherein the maximum total scaled transmit power scales logarithmically with a bandwidth scaling factor of a flexible bandwidth carrier system.

41. The computer program product of claim 40, wherein the maximum total scaled transmit power equals a maximum total transmit power minus floor (10 Log₁₀ N), where N equals the bandwidth scaling factor of the flexible bandwidth carrier system.

42. The computer program product of claim 33, wherein a base station determines at least the first transmit power limit or the second transmit power limit and transmits them to one or more user equipment.

43. The computer program product of claim 33, further comprising:
code for adjusting a pilot to traffic power ratio based on a bandwidth scaling factor.

44. The computer program product of claim 43, further comprising:
code for determining one or more gain factors with respect to the adjusted pilot to traffic power ratio.

45. The computer program product of claim 33, wherein a user equipment determines at least the first transmit power limit or the second transmit power limit with respect to a maximum total transmit power.

46. The computer program product of claim 33, wherein the wireless communications system includes a flexible bandwidth carrier system.

47. A wireless communications device for configuring maximum allowed transmit power in a wireless communications system, the device comprising:
at least one processor configured to:
determine at least first transmit power limit for at least a first traffic type;
determine at least a second transmit power limit for at least a second traffic type; and
utilize at least the first transmit power limit with respect to the first traffic type or the second transmit power limit with respect to the second traffic type.

48. The wireless communications device of claim 47, wherein the first traffic type includes a voice traffic type and the second traffic type includes at least a data traffic type.

49. The wireless communications device of claim 47, wherein the at least one processor is further configured to:
transmit the one or more transmit power limits.

50. The wireless communications device of claim 47, wherein the at least one processor is further configured to:
receive the one or more transmit power limits.

51. The wireless communications device of claim 47, wherein the first transmit power limit includes a maximum total transmit power.

52. The wireless communications device of claim 47, wherein at least second transmit power limit includes a maximum total scaled transmit power.

53. The wireless communications device of claim 52, wherein the maximum scaled transmit power maintains a fixed power spectrum density (PSD) with respect to a normal bandwidth system.

54. The wireless communications device of claim 52, wherein the maximum total scaled transmit power scales logarithmically with a bandwidth scaling factor of a flexible bandwidth carrier system.

55. The wireless communications device of claim 54, wherein the maximum total scaled transmit power equals a maximum total transmit power minus floor (10 Log₁₀) N), where N equals the bandwidth scaling factor of the flexible bandwidth carrier system.

56. The wireless communications device of claim 47, wherein a base station determines at least the first transmit power limit or the second transmit power limit and transmits them to one or more user equipment.

57. The wireless communications device of claim 47, wherein the at least one processor is further configured to:
adjust a pilot to traffic power ratio based on a bandwidth scaling factor.

58. The wireless communications device of claim 57, wherein the at least one processor is further configured to:
determine one or more gain factors with respect to the adjusted pilot to traffic power ratio.

59. The wireless communications device of claim 47, wherein a user equipment determines at least the first transmit power limit or the second transmit power limit with respect to a maximum total transmit power.

60. The wireless communications device of claim 47, wherein the wireless communications system includes a flexible bandwidth carrier system.
